(19) United States
(12) Patent Application Publication
(10) Pub. No.: US 2026/0313516 A1
(43) Pub. Date: Oct. 8, 2026

(54) IMPROVED FRONTHAUL TRAFFIC TO RADIO UNIT

(71) Applicant: Outdoor Wireless Networks LLC, Richardson, TX (US)

(72) Inventors: Suresh N. Sriram, Bangalore (IN); Yogesh C.S, Bengaluru (IN)

(73) Assignee: Outdoor Wireless Networks LLC, Richardson, TX (US)

(21) Appl. No.: 19/483,147

(22) PCT Filed: May 2, 2024
(86) PCT No.: PCT/US2024/027437

§ 371 Date: Nov. 10, 2025

(30) Foreign Application Priority Data
May 10, 2023 (IN) 202341032953

(51) Int. Cl. H04W 40/24; H04B 7/024; H04L 61/5007

(52) U.S. Cl. CPC H04W 40/24; H04B 7/024; H04L 61/5007

(57) ABSTRACT

Systems and methods for improving fronthaul traffic to radio unit are described herein. In certain embodiments, a distributed antenna system (DAS) includes a master unit. Additionally, a DAS includes a plurality of radio units coupled to receive control-plane data and user-plane data from the master unit. Further, the master unit stores destination IP addresses for different combinations of radio units in the plurality of radio units, wherein the control-plane data and the user-plane data are transmitted to a combination of radio units in the different combinations of radio units associated with a specific destination IP address.

### CROSS-REFERENCE TO RELATED APPLICATIONS

This application claims the benefit of Indian Provisional No. 202341032953, filed on May 10, 2023, which is hereby incorporated herein by reference in its entirety.

### BACKGROUND

A distributed antenna system (DAS) typically includes one or more central units or nodes (also referred to here as “central access nodes (CANs)” or “master units”) that are communicatively coupled to a plurality of remotely located access points or antenna units (also referred to here as “remote units” or “radio units”). Each access point can be coupled directly to one or more of the central access nodes. Also, each access point can be coupled indirectly via one or more other remote units or via one or more intermediary or expansion units or nodes (also referred to here as “transport expansion nodes (TENs)”). A DAS is typically used to improve the coverage provided by one or more base stations coupled to the central access nodes. These base stations can be coupled to the one or more central access nodes via one or more cables or via a wireless connection, for example, using one or more donor antennas. The wireless service provided by the base stations can include commercial cellular service or private or public safety wireless communications.

In general, each central access node receives one or more downlink signals from one or more base stations and generates one or more downlink transport signals derived from one or more of the received downlink base station signals. Each central access node transmits one or more downlink transport signals to one or more of the access points. Each access point receives the downlink transport signals transmitted to it from one or more central access nodes and uses the received downlink transport signals to generate one or more downlink radio frequency signals for radiation from one or more coverage antennas associated with that access point. The downlink radio frequency signals are radiated for reception by user equipment (UEs). Typically, the downlink radio frequency signals associated with each base station are simulcasted from multiple remote units. In this way, the DAS increases the coverage area for the downlink capacity provided by the base stations.

Likewise, each access point receives one or more uplink radio frequency signals transmitted from the user equipment. Each access point generates one or more uplink transport signals derived from the one or more uplink radio frequency signals and transmits the one or more uplink transport signals to one or more of the central access nodes. Each central access node receives the respective uplink transport signals transmitted to it from one or more access points and uses the received uplink transport signals to generate one or more uplink base station radio frequency signals that are provided to the one or more base stations associated with that central access node. Typically, receiving the uplink signals involves, among other things, summing uplink signals received from the multiple access points to produce the base station signal provided to each base station. In this way, the DAS increases the coverage area for the uplink capacity provided by the base stations.

A DAS can use either digital transport, analog transport, or combinations of digital and analog transport to generate and communicate the transport signals between the central access nodes, the access points, and any transport expansion nodes.

Traditionally, a DAS is operated in a “full simulcast” mode in which downlink signals for each base station are transmitted from multiple access points of the DAS and in which uplink signals for each base station are generated by summing uplink data received from the multiple access points.

The 3GPP fifth generation (5G) radio access network (RAN) architecture includes a set of base stations (also referred to as “gNBs”) connected to the 5G core network (5GC) and to each other. Each gNB typically comprises three entities—a centralized unit (CU), a distributed unit (DU), and a set of one or more radio units (RUs). The CU can be further split into one or more CU control plane entities (CU-CPs) and one or more CU user plane entities (CU-UPs). The functions of the RAN can be split among these entities in various ways. For example, the functional split between the DU and the RUs can be configured so that the DU implements some of the Layer-1 processing functions (for the wireless interface), and each RU implements the Layer-1 functions that are not implemented in the DU as well as the basic RF and antenna functions. The DU is coupled to each RU using a fronthaul network (for example, one implemented using a switched Ethernet network) over which data is communicated between the DU and each RU. The data includes, for example, user-plane data (for example, in-phase and quadrature (IQ) data representing time-domain or frequency-domain symbols). One example of such a configuration is a “cloud radio access network” or “cloud RAN” configuration in which each CU and DU are associated with multiple RUs.

### SUMMARY

Systems and methods for improving fronthaul traffic to radio unit are described herein. In certain embodiments, a distributed antenna system (DAS) includes a master unit. Additionally, a DAS includes a plurality of radio units coupled to receive control-plane data and user-plane data from the master unit. Further, the master unit stores destination IP addresses for different combinations of radio units in the plurality of radio units, wherein the control-plane data and the user-plane data are transmitted to a combination of radio units in the different combinations of radio units associated with a specific destination IP address.

### BRIEF DESCRIPTION OF DRAWINGS

Drawings accompany this description and depict only some embodiments associated with the scope of the appended claims. Thus, the described and depicted embodiments should not be considered limiting in scope. The accompanying drawings and specification describe the exemplary embodiments, and features thereof, with additional specificity and detail, in which:

FIGS. 1A-1C are block diagrams illustrating exemplary embodiments of a virtualized DAS according to an aspect of the present disclosure;

FIG. 2 is a block diagram illustrating an exemplary embodiment of an access point for use in a virtualized DAS according to an aspect of the present disclosure;

FIGS. 3A-3D are block diagrams illustrating exemplary embodiments of a virtualized DAS having access points coupled to virtual MUs according to an aspect of the present disclosure;

FIG. 4 is a block diagram illustrating an exemplary embodiment of a virtualized DAS where an RF interface bypasses a virtualized MU according to an aspect of the present disclosure;

FIG. 5 is a block diagram illustrating a system for improved fronthaul traffic to radio units according to an aspect of the present disclosure; and

FIG. 6 is a flowchart diagram of a method for ccording to an aspect of the present disclosure.

Per common practice, the drawings do not show the various described features according to scale, but the drawings show the features to emphasize the relevance of the features to the example embodiments.

### DETAILED DESCRIPTION

The following detailed description refers to the accompanying drawings that form a part of the present specification. The drawings, through illustration, show specific illustrative embodiments. However, it is to be understood that other embodiments may be used and that logical, mechanical, and electrical changes may be made.

Systems and methods for improving front-haul traffic to radio units are provided.

Specifically, the control-plane and user-plane data for PDSCH/UE specific channels and signals are transmitted over the fronthaul to only those radio units (RUs) included in the simulcast zones for the associated user equipment (UE). In particular, RUs within a simulcast zone use the control-plane and user-plane data for specific UEs, where the RUs use the control-plane and user-plane to generate the analog RF signals transmitted from the RUs in the simulcast zone. Corresponding control-plane and user-plane data for other downlink channels/signals (e.g., SSB/PDCCH/CSI-RS) are communicated over fronthaul to all RUs serving a cell because RUs use this control-plane and user-plane data in connection with generating the analog RF signals wirelessly transmitted from the RUs. By not communicating control-plane and user-plane data in connection with generating the analog RF signals wirelessly transmitted from those RUs, fronthaul bandwidth usage and RU processing load will be reduced.

In some communication systems, like distributed antenna systems (DAS), different UE combinations can be associated with different simulcast zones and combining zones. Distribution units (DUs) communicate fronthaul data with RUs in a simulcast/combining zone for a UE through a fronthaul network. The “size” of a simulcast zone or combining zone refers to the number of RUs included in a simulcast zone or combining zone. Generally, the respective simulcast zone and combining zone for a UE includes RUs with the “best” or “strongest” signal reception or transmission characteristics for a particular UE.

In one exemplary embodiment, a serving DU can determine the simulcast zone and combining zone for a UE by a “signature vector” (SV) associated with the UE. Each signature vector may include a respective element for each RU in communication with a gNB. In one example of a signature vector, where a gNB communicates with 32 RUs, each signature vector will include 32 elements, one for each of the 32 RUs. Each element of the signature vector corresponds to one of the RUs associated with the gNB. Additionally, each element of the signature vector may include one or more numerical values associated with the signal transmission or reception characteristics for the UE.

In certain embodiments, the elements of the signature vector for each UE can be determined by a base station or master unit based on information contained in uplink transmissions from the UE. The relative signal reception metrics are determined to represent which RUs will provide strong signal transmission and reception characteristics for transmitting downlink transmissions to the UE and receiving uplink transmissions from the UE. Additionally, the relative signal reception metrics may be determined to identify simulcast zones for the UE. For example, the signature vector can be determined based on received power measurements made at each of the RUs of the gNB for one or more uplink transmissions from the UE (for example, initially Physical Random Access Channel (PRACH) transmissions and thereafter Sounding Reference Signals (SRS) transmissions). More specifically, each RU of the gNB, upon receiving uplink transmissions, can measure or otherwise determine a signal reception metric indicative of the power level of the transmissions received by that RU from the UE. One example of such a signal reception metric is a signal-to-interference plus noise ratio (SINR).

In some embodiments, each gNB may be configured to determine a signature vector for a UE upon connection to the cell (for example, based on a PRACH transmission and/or a previously determined signature vector for that UE) and update the signature vector for the UE over the course of the UE's connection to the cell based on SRS transmissions from the UE. For the purposes of determining and updating a UE's signature vector, each RU of the gNB can communicate the respective signal reception metrics periodically without an explicit request from the DU and/or can communicate the signal reception metrics in response to an explicit request from the DU (for example, using a polling mechanism).

One way that the respective signature vector determined for a given UE can be used to determine the respective simulcast zone or combining zone for that UE is by using the signature vector to calculate a “total zone power” and a “total available power” for that UE.

The total zone power for a given UE is the sum of the respective signal reception metrics determined for that UE corresponding to the RUs currently included in the zone under analysis. The “total available power” for the UE is the sum of the signal reception metrics determined for that UE that correspond to all of the RUs. The simulcast zone or combining zone for a UE can be determined by including enough RUs in the simulcast zone so that the total zone power for the UE is within a threshold amount of the total available power for the UE. More specifically, a respective zone for a UE can be determined by starting with an empty zone for that UE, sorting the RUs based on the respective corresponding signal reception metrics determined for that UE in descending order from strongest power to weakest power, and adding, to the zone for that UE, successive RUs (according to the resulting sorted descending order) until the total zone power calculated for that UE is within a threshold amount of the respective total available power calculated for that UE or until the number of RUs included in the respective zone for that UE is equal to a predetermined maximum value (also referred to here as the “zone cap”). The size of a simulcast zone or combining zone may be limited by the zone cap.

In this exemplary embodiment, the gNB is configured to implement “frequency reuse.” As noted above, “downlink frequency reuse” refers to situations where separate downlink user data intended for different UEs is simultaneously wirelessly transmitted to the UEs using the same physical resource blocks (PRBs) for the same cell. Likewise, as noted above, “uplink frequency reuse” refers to situations where separate uplink user data is simultaneously wirelessly transmitted from different UEs using the same PRBs for the same cell. Generally, for those PRBs where downlink or uplink frequency reuse is used, the respective simulcast zone or the combining zone for the multiple UEs that are “in reuse together” have no RUs in common. Typically, frequency reuse can be used when the UEs in reuse together are sufficiently physically separated from each other so that the co-channel interference resulting from the different simultaneous wireless transmissions is sufficiently low (that is, where there is sufficient RF isolation).

Each gNB is configured to use all RUs to receive uplink transmissions from UEs on the Physical Random Access Channel (PRACH). All RUs are used because the PRACH is used by a UE, among other things, to access the cell initially and re-establish access after being idle. Also, the gNB may have no simulcast zone or combining zone assigned to the UE, or the simulcast zone or combining zone assigned to the UE may be “stale” and not properly reflect the current location of the UE (for example, if the location of the UE changed significantly while the UE was an idle state).

Also, each gNB is configured to update the signature vector (and, therefore, the simulcast zone and combining zone) for each UE using SRS transmissions from that UE. Consequently, in this exemplary embodiment, each gNB is configured to use all RUs to receive uplink SRS transmissions from UEs.

In some multi-radio unit deployments, the transmission of certain packets to a simulcast zone for a UE may be sent over the fronthaul to all of the RUs serving a particular cell. The RUs that are not associated with the particular simulcast zone will receive the control-plane and user-plane data even though those RUs will not actually use this control-plane and user-plane data in connection with generating the analog RF signals wirelessly transmitted from those RUs but instead will discard it. For example, the RUs may identify such control-plane and user-plane data based on the RUID field included in the headers of the control-plane and user-plane data. However, relying on the RUs to identify and discard such data wastefully consumes fronthaul bandwidth and the processing capacity of the RUs.

In certain embodiments, to do this, for the downlink, control-plane, and user-plane data for PDSCH/UE specific channels and signals, the master unit transmits the control-plane and user-plane data over the fronthaul to only those RUs in the associated UE's simulcast zone—either an IP unicast transmission or an IP multicast transmission to a multicast group that only includes the RUs in the simulcast zone for the associated UE (also referred to herein as “limited multicast” fronthaul transmission). Control-plane and user-plane data for the other downlink channels and signals that would be used by all of the RUs are transmitted over the fronthaul to all of the RUs used to serve the cell (also referred to herein as “full multicast” or “broadcast” fronthaul transmission). For example, control-plane and user-plane data for signals like the SSB, PDCCH, CSI-RS, and the like will be used by all of the RUs in connection with generating the analog RF signals wirelessly transmitted from those RUs. Thus, the control-plane and user-plane data for these channels and signals are sent with a full multicast to all of the RUs serving the cell. In some embodiments, when a UE is discovered by the network or an RU is added to the system, the system may generate a unicast IP address for the joining RU and a limited multicast IP address for the RUs in the simulcast zone for the UE.

In exemplary embodiments, the MU and any intermediate nodes between the MU and the RU may maintain, store, and update a database that contains a list of destination IP addresses for the RUs and the RUs associated with any simulcast zones for a particular UE. When an MU transmits control-plane and user-plane data to an RU or multiple RUs in a simulcast zone, the MU may look up the IP address associated with the simulcast zone in the database and place the IP address in a custom header for control-plane and user-plane data to be transmitted to the RUs. Any intermediate nodes, like an aggregate switch, access switch, or intermediate combining nodes, may then read the IP address from the custom header, lookup the IP address in the tables maintained on the respective node, and route the data to the appropriate RU. By routing the control-plane and user-plane data to only the intended RU/RUs, the system reduces the fronthaul bandwidth usage and the processing load of the RUS.

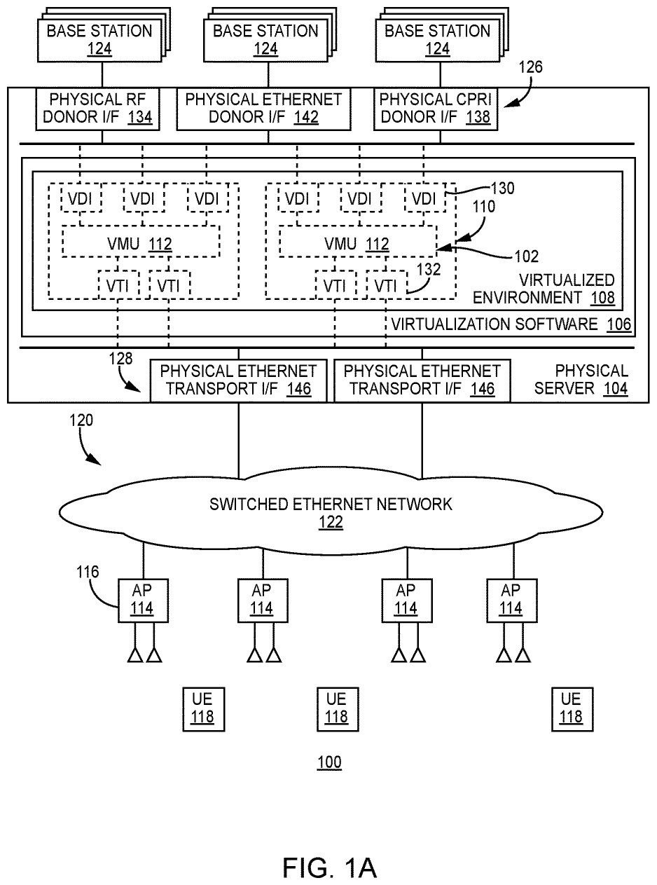

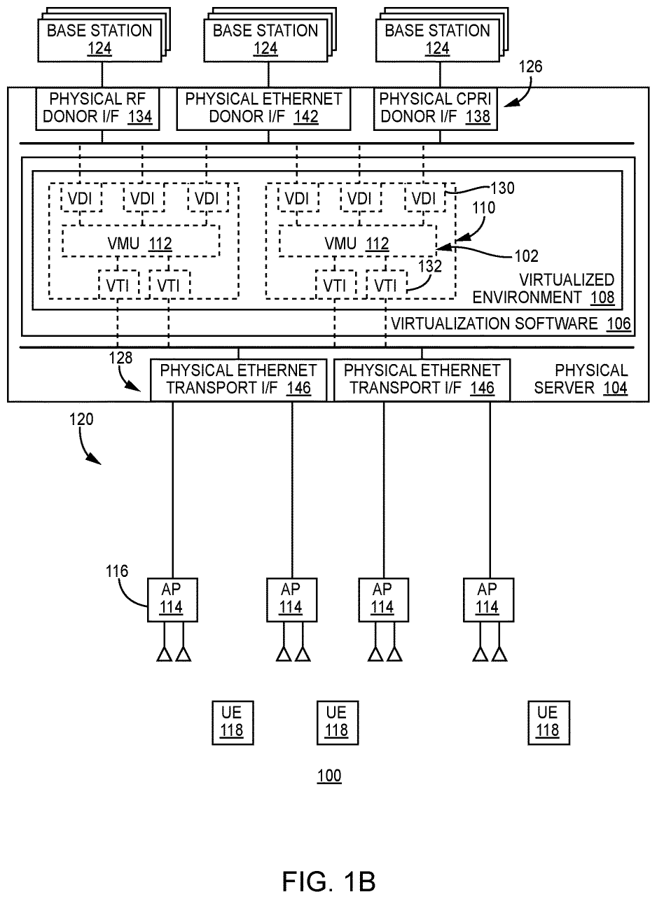

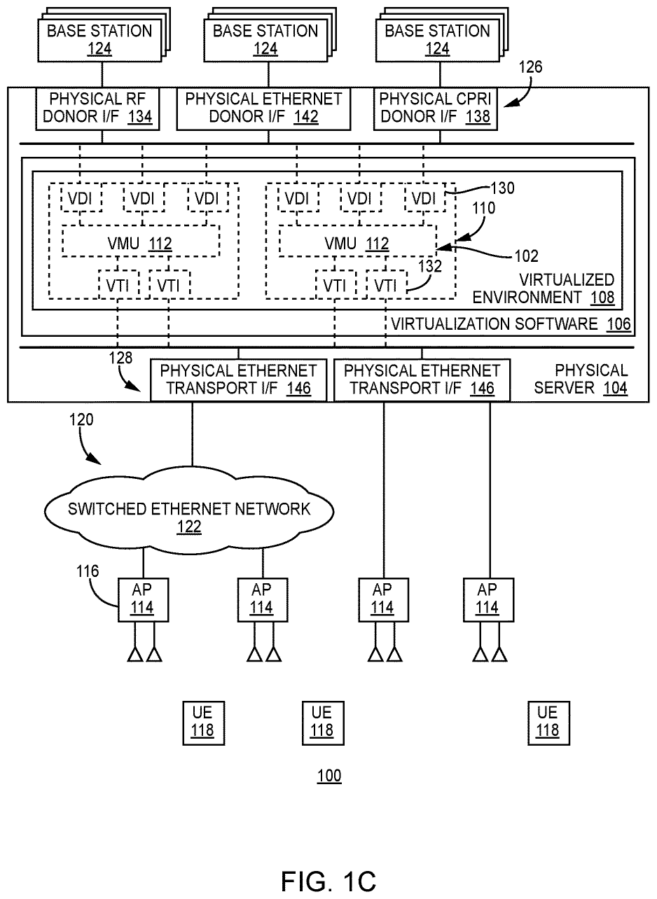

FIGS. 1A-1C are block diagrams illustrating one exemplary embodiment of a virtualized DAS (vDAS) 100 that can receive signals from multiple sources. While a vDAS is shown, some of the features described below may also apply to a non-virtualized DAS, in the exemplary embodiment of the virtualized DAS 100 shown in FIGS. 1A-1C, one or more nodes or functions of a traditional DAS (such as a master unit or CAN) are implemented using one or more virtual network functions (VNFs) 102 executing on one or more physical server computers (also referred to here as “physical servers” or just “servers”) 104 (for example, one or more commercial-off-the-shelf (COTS) servers of the type that are deployed in data centers or “clouds” maintained by enterprises, communication service providers, or cloud services providers).

Each such physical server computer 104 is configured to execute software configured to implement the various functions and features described here as being implemented by the associated VNF 102. Each such physical server computer 104 comprises one or more programmable processors for executing such software. The software comprises program instructions that are stored (or otherwise embodied) on or in an appropriate non-transitory storage medium or media (such as flash or other non-volatile memory, magnetic disc drives, and/or optical disc drives) from which at least a portion of the program instructions are read by the respective programmable processor for execution thereby. Both local storage media and remote storage media (for example, storage media that is accessible over a network), as well as removable media, can be used. Each such physical server computer 104 also includes memory for storing the program instructions (and any related data) during execution by the respective programmable processor.

In the example shown in FIGS. 1A-1C, virtualization software 106 is executed on each physical server computer 104 to provide a virtualized environment 108 in which one or more virtual entities 110 (such as one or more virtual machines and/or containers) are used to deploy and execute the one or more VNFs 102 of the vDAS 100. In the following description, it should be understood that references to “virtualization” are intended to refer to, and include within their scope, any type of virtualization technology, including “container” based virtualization technology (such as, but not limited to, Kubernetes).

In the example shown in FIGS. 1A-1C, the vDAS 100 comprises at least one virtualized master unit (vMU) 112 and a plurality of access points (APs) (also referred to herein as “remote antenna units” (RAUs) or “radio units” (RUs)) 114. Each vMU 112 is configured to implement the functions normally carried out by a physical master unit or CAN in a traditional DAS.

Each of the vMUs 112 is implemented as a respective VNF 102 deployed on one or more physical servers 104. Each of the APs 114 is implemented as a physical network function (PNF) and is deployed in or near a physical location where coverage is to be provided by an associated AP 114.

Each of the APs 114 includes, or is otherwise coupled to, one or more coverage antennas 116 via which downlink radio frequency (RF) signals are radiated for reception by user equipment (UEs) 118 and via which uplink RF signals transmitted from UEs 118 are received. Each of the APs 114 is communicatively coupled to the respective one or more vMUs 112 (and the physical server computers 104 on which the vMUs 112 are deployed) using a fronthaul network 120. The fronthaul network 120 used for transport between each vMU 112 and the APs 114 can be implemented in various ways. Various examples of how the fronthaul network 120 can be implemented are illustrated in FIGS. 1A-1C. In the example shown in FIG. 1A, the fronthaul network 120 is implemented using a switched Ethernet network 122 that is used to communicatively couple each AP 114 to each vMU 112 serving that AP 114. That is, in contrast to a traditional DAS in which each AP is coupled to each CAN serving it using only point-to-point links, in the vDAS 100 shown in FIG. 1A, each AP 114 is coupled to each vMU 112 serving it, using at least some of the shared communication links.

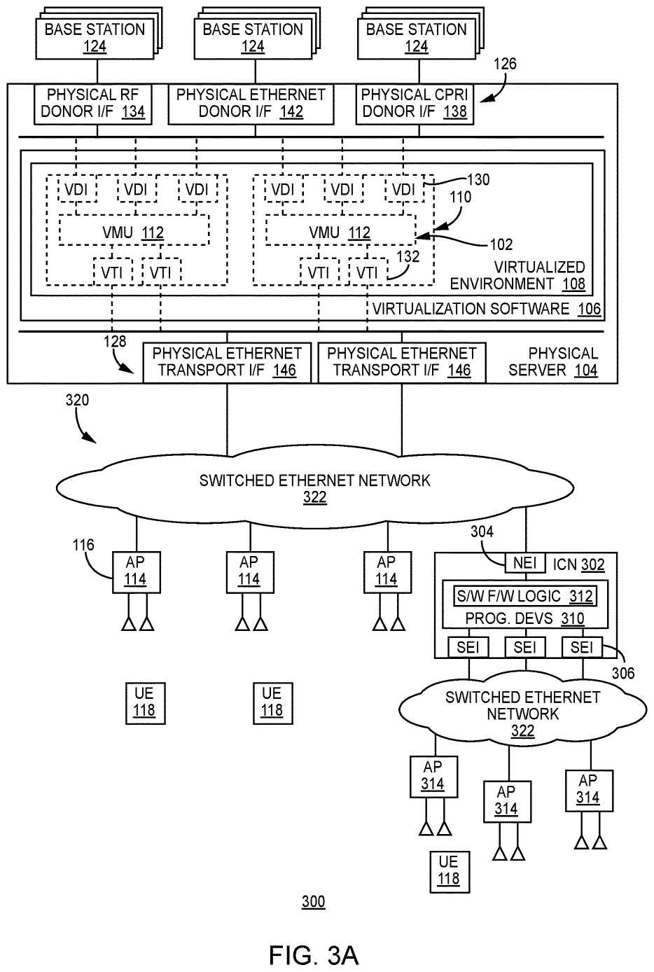

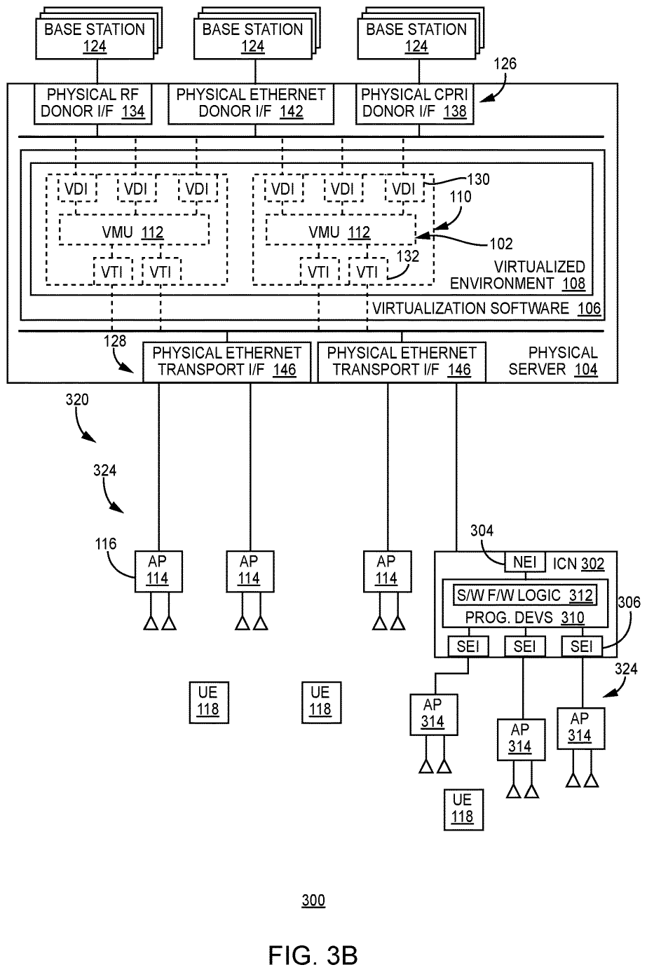

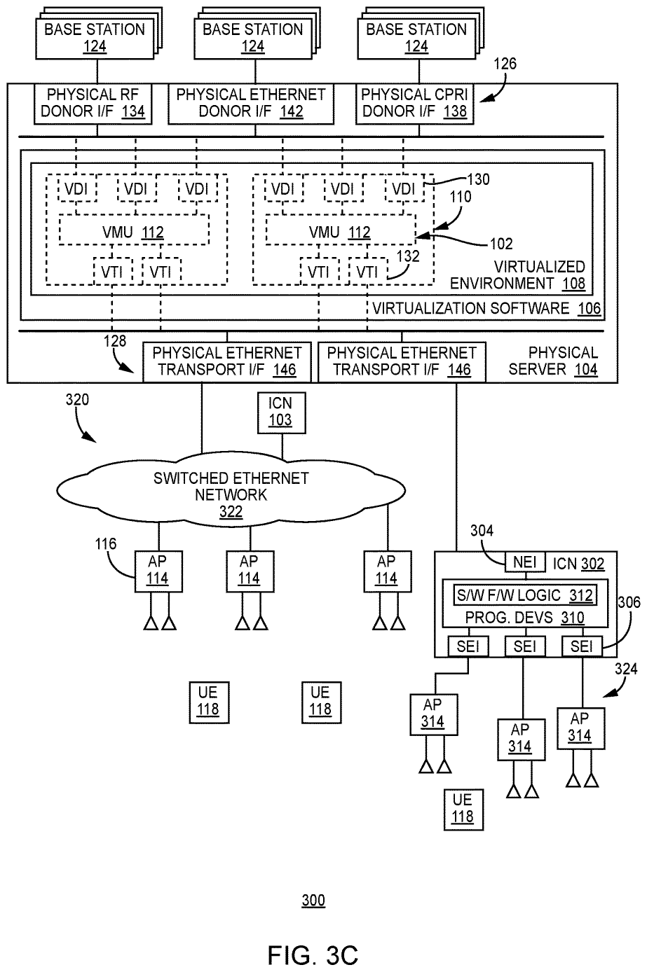

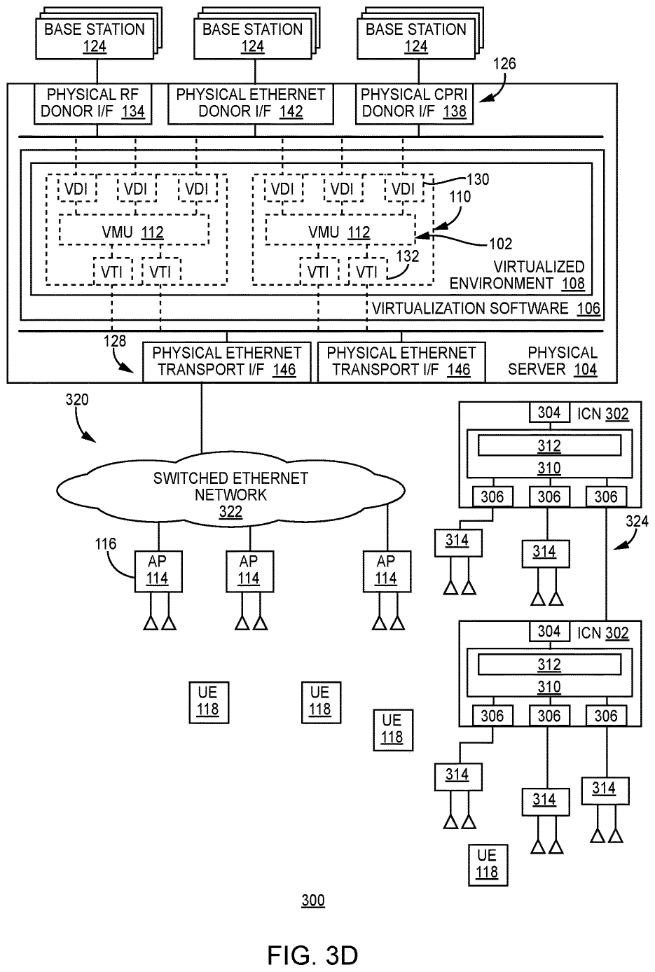

In the example shown in FIG. 1B, the fronthaul network 120 is implemented using only point-to-point Ethernet links, where each AP 114 is coupled to each serving vMU 112 serving it via a respective one or more point-to-point Ethernet links. In the example shown in FIG. 1C, the fronthaul network 120 is implemented using a combination of a switched Ethernet network 122 and point-to-point Ethernet links, where at least one AP 114 is coupled to a vMU 112 serving it at least in part using the switched Ethernet network 122 and at least one AP 114 where at least one AP 114 is coupled to a vMU 112 serving it at least in part using at least one point-to-point Ethernet link 124. FIGS. 3A-3D are block diagrams illustrating other examples in which one or more intermediate combining nodes (ICNs) 302 are used. The examples shown in FIGS. 3A-3D are described below. It is to be understood, however, that FIGS. 1A-1C and 3A-3D illustrate only a few examples of how the fronthaul network (and the vDAS more generally) can be implemented and that other variations are possible.

The vDAS 100 is configured to be coupled to one or more base stations 124, to improve the coverage provided by the base stations 124. That is, each base station 124 is configured to provide wireless capacity, whereas the vDAS 100 is configured to provide improved wireless coverage for the wireless capacity provided by the base station 124. As used here, unless otherwise explicitly indicated, references to “base station” include both (1) a “complete” base station that interfaces with the vDAS 100 using the analog radio frequency (RF) interface that would otherwise be used to couple the complete base station to a set of antennas as well as (2) a first portion of a base station 124 (such as a baseband unit (BBU), distributed unit (DU), or similar base station entity) that interfaces with the vDAS 100 using a digital fronthaul interface that would otherwise be used to couple that first portion of the base station to a second portion of the base station (such as a remote radio head (RRH), radio unit (RU), or similar radio entity). In the latter case, different digital fronthaul interfaces can be used (including, for example, a Common Public Radio Interface (CPRI) interface, an evolved CPRI (eCPRI) interface, an IEEE 1914.3 Radio-over-Ethernet (RoE) interface, a functional application programming interface (FAPI) interface, a network FAPI (nFAPI) interface), or an Open-RAN (O-RAN) fronthaul interface) and different functional splits can be supported (including, for example, functional split 4, functional split 7-2, and functional split 6).

Each base station 124 coupled to the vDAS 100 can be co-located with the vMU 112 to which it is coupled. A co-located base station 124 can be coupled to the vMU 112 to which it is coupled using one or more point-to-point links (for example, where the co-located base station 124 comprises a 4G LTE BBU supporting a CPRI fronthaul interface, the 4G LTE BBU can be coupled to the vMU 112 using one or more optical fibers that directly connect the BBU to the vMU 112) or a shared network (for example, where the co-located base station 124 comprises a DU supporting an Ethernet-based fronthaul interface (such as an O-RAN or eCPRI fronthaul interface), the co-located DU can be coupled to the vMU 112 using a switched Ethernet network). Each base station 124 coupled to the vDAS 100 can also be located remotely from the vMU 112 to which it is coupled. A remote base station 124 can be coupled to the vMU 112 to which it is coupled via a wireless connection (for example, by using a donor antenna to wirelessly couple the remote base station 124 to the vMU 112 using an analog RF interface) or via a wired connection (for example, where the remote base station 124 comprises a DU supporting an Ethernet-based fronthaul interface (such as an O-RAN or eCPRI fronthaul interface), the remote DU can be coupled to the vMU 112 using an Internet Protocol (IP)-based network such as the Internet).

The vDAS 100 described here is especially well-suited for use in deployments in which base stations 124 from multiple wireless service operators share the same vDAS 100 (including, for example, neutral host deployments or deployments where one wireless service operator owns the vDAS 100 and provides other wireless service operators with access to its vDAS 100). For example, multiple vMUs 112 can be instantiated, where a different group of one or more vMUs 112 can be used with each of the wireless service operators (and the base stations 124 of that wireless service operator). The vDAS 100 described here is especially well-suited for such deployments because vMUs 112 can be easily instantiated to support additional wireless service operators. The vMUs can be easily instantiated even if an additional physical server computer 104 is needed to instantiate a new vMU 112 because such physical server computers 104 are either already available in such deployments or can be easily added at a low cost (for example, because of the COTS nature of such hardware).

The physical server computer 104 on which each vMU 112 is deployed includes one or more physical donor interfaces 126 that are each configured to communicatively couple the vMU 112 (and the physical server computer 104 on which it is deployed) to one or more base stations 124. Also, the physical server computer 104 on which each vMU 112 is deployed includes one or more physical transport interfaces 128 that are each configured to communicatively couple the vMU 112 (and the physical server computer 104 on which it is deployed) to the fronthaul network 120 (and ultimately the APs 114). Each physical donor interface 126 and physical transport interface 128 is a physical network function (PNF) (for example, implemented as a Peripheral Computer Interconnect Express (PCIe) device) deployed in or with the physical server computer 104.

In the example shown in FIGS. 1A-1C, each physical server computer 104 on which each vMU 112 is deployed includes separate physical donor and transport interfaces 126 and 128. However, it is to be understood that, in other embodiments, a single set of physical interfaces 126 and 128 can be used for both donor purposes (that is, communication between the vMU 112 to one or more base stations 124) and for transport purposes (that is, communication between the vMU 112 and the APs 114 over the fronthaul network 120).

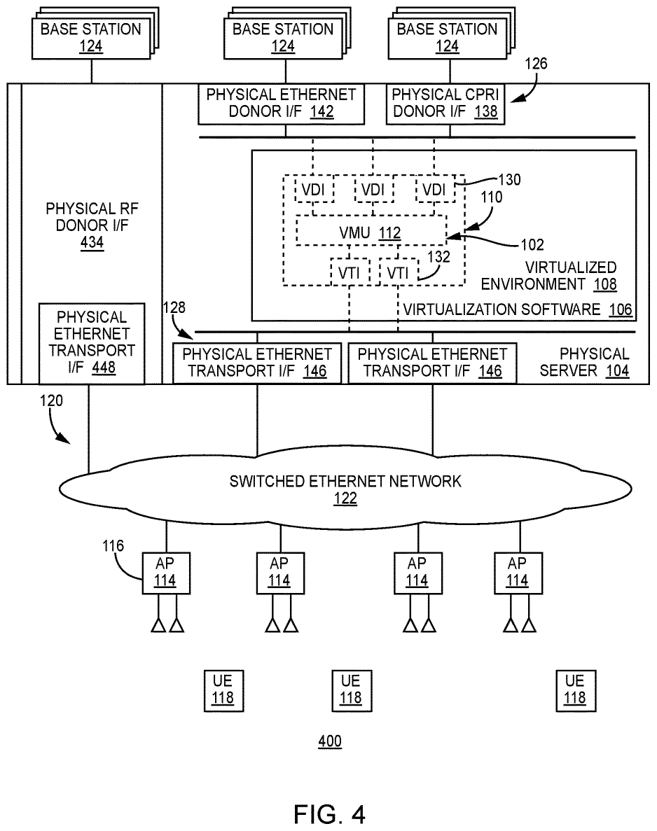

In the exemplary embodiment shown in FIGS. 1A-1C, the physical donor interfaces 126 comprise one or more physical RF donor interfaces (also referred to here as “physical RF donor cards”) 134. Each physical RF donor interface 134 is in communication with one or more vMUs 112 executing on the physical server computer 104 in which that physical RF donor interface 134 is deployed (for example, by communicating over a PCIe lane with a central processing unit (CPU) used to execute each such vMU 112). Each physical RF donor interface 134 includes one or more sets of physical RF ports (not shown) to couple the physical RF donor interface 134 to one or more base stations 124 using an analog RF interface. Each physical RF donor interface 134 is configured, for each base station 124 coupled to it, to receive downlink analog RF signals from the base station 124 via respective RF ports, convert the received downlink analog RF signals to digital downlink time-domain data, and output it to a vMU 112 executing on the same server computer 104 in which that RF donor interface 134 is deployed. Also, each physical RF donor interface 134 is configured, for each base station 124 coupled to it, to receive summed digital uplink time-domain data from the vMU 112, convert the received summed digital uplink time-domain data to uplink analog RF signals, and output the uplink analog RF signals to the base station 124. Moreover, the digital downlink time-domain data produced and the digital uplink time-domain data received by each physical RF donor interface 134 can be in the form of real digital values or complex (that is, in-phase and quadrature (IQ)) digital values and at baseband (that is, centered around 0 Hertz) or with a frequency offset near baseband or an intermediate frequency (IF). Alternatively, as described in more detail below in connection with FIG. 4, one or more of the physical RF donor interfaces can be configured to bypass the vMU 112 and instead, for the base stations 124 coupled to that physical RF donor interface, have that physical RF donor interface perform the functions described here as being performed by the vMU 112 (including the digital combining or summing of user-plane data).

In the exemplary embodiment shown in FIGS. 1A-1C, the physical donor interfaces 126 also include one or more physical CPRI donor interfaces (also referred to here as “physical CPRI donor cards”) 138. Each physical CPRI donor interface 138 is in communication with one or more vMUs 112 executing on the physical server computer 104 in which that physical CPRI donor interface 138 is deployed (for example, by communicating over a PCIe lane with a CPU used to execute each such vMU 112). Each physical CPRI donor interface 138 includes one or more sets of physical CPRI ports (not shown) to couple the physical CPRI donor interface 138 to one or more base stations 124 using a CPRI interface. More specifically, in this example, each base station 124 coupled to the physical CPRI donor interface 138 comprises a BBU or DU configured to communicate with a corresponding RRH or RU using a CPRI fronthaul interface. Each physical CPRI donor interface 138 is configured, for each base station 124 coupled to it, to receive from the base station 124 via a CPRI port digital downlink data formatted for the CPRI fronthaul interface, extract the digital downlink data, and output it to a vMU 112 executing on the same server computer 104 in which that CPRI donor interface 138 is deployed. Also, each physical CPRI donor interface 138 is configured, for each base station 124 coupled to it, to receive summed digital uplink digital data from the vMU 112, format it for the CPRI fronthaul interface, and output the CPRI formatted data to the base station 124 via a CPRI port.

In the exemplary embodiment shown in FIGS. 1A-1C, the physical donor interfaces 126 also include one or more physical donor Ethernet interfaces 142. Each physical donor Ethernet interface 142 is in communication with one or more vMUs 112 executing on the physical server computer 104 in which that physical donor Ethernet interface 142 is deployed (for example, by communicating over a PCIe lane with a CPU used to execute each such vMU 112). Each physical donor Ethernet interface 142 includes one or more sets of physical donor Ethernet ports (not shown) to couple the physical donor Ethernet interface 142 to one or more base stations 124 so that each vMU 112 can communicate with the one or more base stations 124 using an Ethernet-based digital fronthaul interface (for example, an O-RAN or eCPRI fronthaul interface). More specifically, in this example, each base station 124 coupled to the physical donor Ethernet interface 142 comprises a BBU or DU configured to communicate with a corresponding RRH or RU using an Ethernet-based fronthaul interface. Each donor Ethernet interface 142 is configured, for each base station 124 coupled to it, to receive from the base station 124 digital downlink fronthaul data formatted as Ethernet data, extract the digital downlink fronthaul data, and output it to a vMU 112 executing on the same server computer 104 in which that donor Ethernet interface 142 is deployed. Also, each physical donor Ethernet interface 142 is configured, for each base station 124 coupled to it, to receive summed digital fronthaul data from the vMU 112 and output it to the base station 124 via an Ethernet port.

In the exemplary embodiment shown in FIGS. 1A-1C, the physical transport interfaces 128 comprise one or more physical Ethernet transport interfaces 146. Each physical transport Ethernet interface 146 is in communication with one or more vMUs 112 executing on the physical server computer 104 in which that physical transport Ethernet interface 146 is deployed (for example, by communicating over a PCIe lane with a CPU used to execute each such vMU 112). Each physical transport Ethernet interface 146 includes one or more sets of Ethernet ports (not shown) to couple the physical transport Ethernet interface 146 to the Ethernet cabling used to implement the fronthaul network 120 so that each vMU 112 can communicate with the various APs 114.

In this exemplary embodiment, the virtualization software 106 is configured to implement within the virtual environment 108 a respective virtual interface for each of the physical donor interfaces 126 and physical transport Ethernet interfaces 146 to provide and control access to the associated physical interface by each vMU 112 implemented within that virtual environment 108. That is, the virtualization software 106 is configured so that the virtual entity 110 used to implement each vMU 112 includes a virtual donor interface (VDI) 130 that virtualizes and controls access to the underlying physical donor interface 126. Likewise, the virtualization software 106 is configured so that the virtual entity 110 used to implement each vMU 112 includes a virtual transport interface (VTI) 132 that virtualizes and controls access to the underlying physical transport interface 128. For each port of each physical Ethernet transport interface 146, the physical Ethernet transport interface 146 (and each corresponding virtual transport interface 132) is configured to communicate over a switched Ethernet network or over a point-to-point Ethernet link depending on how the fronthaul network 120 is implemented (more specifically, depending whether the particular Ethernet cabling connected to that port is being used to implement a part of a switched Ethernet network or is being used to implement a point-to-point Ethernet link).

In general, each vMU 112 is configured to receive one or more downlink base station signals from one or more base stations 124 using one or more of the physical donor interfaces 126 and generate downlink transport data derived from the received downlink base station signals. Each vMU 112 is also configured to, for each such base station 124, communicate downlink transport data for that base station 124 to a set of APs 114 used to serve that base station 124. The set of APs 114 used to serve a base station 124 is also referred to here as the “simulcast zone” for that base station 124. Each AP 114 in the simulcast zone of a base station 124 receives downlink transport data for that base station 124 transmitted to it from the serving vMU 112 and uses the received downlink transport data to generate one or more downlink RF signals for that base station 124 that are radiated from the coverage antennas 116 associated with that AP 114. The downlink RF signals are radiated for reception by UEs 118. Typically, the simulcast zone for each base station 124 includes multiple APs 114. In this way, the vDAS 100 increases the coverage area for the downlink capacity provided by the base stations 124. Different base stations 124 (including different base stations 124 from different wireless service operators in deployments where multiple wireless service operators share the same vDAS 100) can have different simulcast zones defined for them.

Likewise, each AP 114 in the simulcast zone of a base station 124 receives one or more uplink RF signals transmitted from UEs 118 being served by the base station 124. Each such AP 114 generates uplink transport data derived from the one or more uplink RF signals and transmits it to the vMU 112 serving that base station 124. The serving vMU 112 receives the respective uplink transport data transmitted from the APs 114 in the base station's simulcast zone. For each base station 124, one or more uplink base station signals are generated by the vMU 112 and associated physical donor interface 126. The uplink base station signals are provided to the base station 124. Typically, the process of generating the uplink base station signals for a base station 124 involves, among other things, combining or summing uplink data received from the APs 114 in the base station's simulcast zone. In this way, the vDAS 100 increases the coverage area for the uplink capacity provided by the base stations 124.

Also, for any base station 124 coupled to the vDAS 100 using a CPRI fronthaul interface or an Ethernet fronthaul interface, the associated vMU 112 is configured to appear to that base station 124 (that is, the associated BBU or DU) as a single RU or RRH of the type that the base station 124 is configured to work with (for example, as a CPRI RU or RRH where the associated BBU or DU is coupled to the vDAS 100 using a CPRI fronthaul interface or as an O-RAN, eCPRI, or RoE RU or RRH where the associated BBU or DU is coupled to the vDAS 100 using an O-RAN, eCPRI, or RoE fronthaul interface). As a part of doing this, the vMU 112 is configured to implement the control-plane, user-plane, synchronization-plane, and management-plane functions that such a RU or RRU would implement. Stated another way, in this example, the vMU 112 is configured to implement a single “virtual” RU or RRH for the associated base station 124 even though multiple APs 114 are actually being used to wirelessly transmit and receive RF signals for that base station 124.

In some implementations, the content of the transport data communicated between each AP 114 and a serving vMU 112 depends on the functional split used by the associated base station 124. That is, where the associated base station 124 comprises a DU or BBU that is configured to use a functional split 7-2, the transport data comprises frequency-domain user plane data. Where the associated base station 124 comprises a DU or BBU that is configured to use functional split 4 or a where the associated base station 124 comprises a “complete” base station that is coupled to a vMU 112 using an analog RF interface, the transport data comprises time-domain user plane data.

In other implementations, the content of the transport data communicated between each AP 114 and each serving vMU 112 is the same regardless of the functional split used by the associated base station 124. For example, in one such implementation, the transport data communicated between each AP 114 and a serving vMU 112 comprises frequency-domain user plane data, regardless of the functional split used by the associated base station 124. In such implementations, the vMU 112 converts the user plane data as needed (for example, by converting the time-domain user plane data to frequency-domain user plane data and generating associated control plane data).

In general, the physical layer baseband processing required to be performed by an RU entity for a given served base station 124 depends on the functional split used for the transport data.

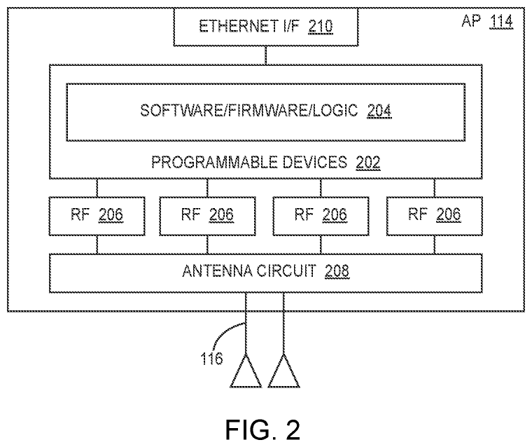

In the exemplary embodiment shown in FIG. 2, the AP 114 comprises multiple radio frequency (RF) modules 206. Each RF module 206 comprises circuitry that implements the RF transceiver functions for a given RU entity implemented using that physical AP 114 and provides an interface to the coverage antennas 116 associated with that AP 114. Each RF module 206 can be implemented using one or more RF integrated circuits (RFICs) and/or discrete components.

Each RF module 206 comprises circuitry that implements, for the associated RU entity, a respective downlink and uplink signal path for each of the coverage antennas 116 associated with that physical AP 114. In one exemplary implementation, each downlink signal path receives the downlink baseband IQ data output by the one or more programmable devices 202 for the associated coverage antenna 116, converts the downlink baseband IQ data to an analog signal (including the various physical channels and associated subcarriers), upconverts the analog signal to the appropriate RF band (if necessary), and filters and power amplifies the analog RF signal. (The up-conversion to the appropriate RF band can be done directly by the digital-to-analog conversion process outputting the analog signal in the appropriate RF band or via an analog upconverter included in that downlink signal path.) The resulting amplified downlink analog RF signal output by each downlink signal path is provided to the associated coverage antenna 116 via an antenna circuit 208 (which implements any needed frequency-division duplexing (FDD) or time-division-duplexing (TDD) functions), including filtering and combining.

In one exemplary implementation, the uplink RF analog signal (including the various physical channels and associated subcarriers) received by each coverage antenna 116 is provided, via the antenna circuit 208, to an associated uplink signal path in each RF module 206.

Each uplink signal path in each RF module 206 receives the uplink RF analog received via the associated coverage antenna 116, low-noise amplifies the uplink RF analog signal, and, if necessary, filters and, if necessary, down-converts the resulting signal to produce an intermediate frequency (IF) or zero IF version of the signal.

Each uplink signal path in each RF module 206 converts the resulting analog signals to real or IQ digital samples and outputs them to the one or more programmable logical devices 202 for uplink signal processing. (The analog-to-digital conversion process can be implemented using a direct RF ADC that can receive and digitize RF signals, in which case no analog down-conversion is necessary.)

Also, in this exemplary embodiment, for each coverage antenna 116, the antenna circuit 208 is configured to combine (for example, using one or more band combiners) the amplified analog RF signals output by the appropriate downlink signal paths of the various RF modules 206 for transmission using each coverage antenna 116 and to output the resulting combined signal to that coverage antenna 116. Likewise, in this exemplary embodiment, for each coverage antenna 116, the antenna circuit 208 is configured to split (for example, using one or more band filters and/or RF splitters) the uplink analog RF signals received using that coverage antenna 116 in order to supply, to the appropriate uplink signal paths of the RF modules 206 used for that antenna 116, a respective uplink analog RF signals for that signal path.

It is to be understood that the preceding description is one example of how each downlink and uplink signal path of each RF module 206 can be implemented; it is to be understood, however, that the downlink and uplink signal paths can be implemented in other ways.

The AP 114 further comprises at least one Ethernet interface 210 that is configured to communicatively couple the AP 114 to the fronthaul network 120 and, ultimately, to the vMU 112. For each port of each Ethernet interface 210, the Ethernet 210 is configured to communicate over a switched Ethernet network or over a point-to-point Ether link depending on how the fronthaul network 120 is implemented (more specifically, depending on whether the particular Ethernet cabling connected to that port is being used to implement a part of a switched Ethernet network or is being used to implement a point-to-point Ethernet link).

In one example of the operation of the vDAS 100 of FIGS. 1A-1C and 2, each base station 124 coupled to the vDAS 100 is served by a respective set of APs 114. As noted above, the set of APs 114 serving each base station 124 is also referred to here as the “simulcast zone” for that base station 124 and different base stations 124 (including different base stations 124 from different wireless service operators in deployments where multiple wireless service operators share the same vDAS 100) can have different simulcast zones defined for them.

In the downlink direction, one or more downlink base station signals from each base station 124 are received by a physical donor interface 126 of the vDAS 100, which generates downlink base station data using the received downlink base station signals and provides the downlink base station data to the vMU 112.

The form that the downlink base station signals take and how the downlink base station data is generated from the downlink base station signals depends on how the base station 124 is coupled to the vDAS 100.

For example, where the base station 124 is coupled to the vDAS 100 using an analog RF interface, the base station 124 is configured to output from its antenna ports a set of downlink analog RF signals. Thus, in this example, the one or more downlink base station signals comprise the set of downlink analog RF signals output by the base station 124 that would otherwise be radiated from a set of antennas coupled to the antenna ports. In this example, the physical donor interface 126 used to receive the downlink base station signals comprises a physical RF donor interface 134. Each of the downlink analog RF signals is received by a respective RF port of the physical RF donor interface 134 installed in the physical server computer 104 executing the vMU 112. The physical RF donor interface 134 is configured to receive each downlink analog RF signal (including the various physical channels and associated subcarriers) output by the base station 124 and generate the downlink base station data by generating corresponding time-domain baseband in-phase and quadrature (IQ) data from the received download analog RF signals (for example, by performing an analog-to-digital (ADC) and digital down-conversion process on the received downlink analog RF signal). The generated downlink base station data is provided to the vMU 112 (for example, by communicating it over a PCIe lane to a CPU used to execute each vMU 112).

In another example, the base station 124 comprises a BBU or DU that is coupled to the vDAS 100 using a CPRI fronthaul interface. In this example, the one or more downlink base station signals comprise the downlink CPRI fronthaul signal output by the base station 124 that would otherwise be communicated over a CPRI link to a RU. In this example, the physical donor interface 126 used to receive the one or more downlink base station signals comprises a physical CPRI donor interface 138. The downlink CPRI fronthaul signal is received by a CPRI port of the physical CPRI donor interface 138 installed in the physical server computer 104 executing the vMU 112. The physical CPRI donor interface 138 is configured to receive the downlink CPRI fronthaul signal, generate the downlink base station data by extracting downlink CPRI messages, and provide the generated downlink base station data to the vMU 112 (for example, by communicating it over a PCIe lane to a CPU used to execute the vMU 112). That is, in this example, the downlink base station data comprises the downlink CPRI messages extracted from the downlink CPRI fronthaul signal.

In another example, the base station 124 comprises a BBU or DU that is coupled to the vDAS 100 using an Ethernet fronthaul interface (for example, an O-RAN, eCPRI, or RoE fronthaul interface). In this example, the one or more downlink base station signals comprise the downlink Ethernet fronthaul signals output by the base station 124 (that is, the BBU or DU) that would otherwise be communicated over an Ethernet network to a RU. In this example, the physical donor interface 126 used to receive the one or more downlink base station signals comprises a physical Ethernet donor interface 142. The physical Ethernet donor interface 142 is configured to receive the downlink Ethernet fronthaul signals, generate the downlink base station data by extracting the downlink messages communicated using the Ethernet fronthaul interface, and provide the messages to the vMU 112 (for example, by communicating it over a PCIe lane to a CPU used to execute each the vMU 112). That is, in this example, the downlink base station data comprises the downlink messages extracted from the downlink Ethernet fronthaul signals.

The vMU 112 generates downlink transport data using the received downlink base station data and communicates, using a physical transport Ethernet interface 146, the downlink transport data from the vMU 112 to the set of APs 114 serving the base station 124.

The generated downlink transport data is communicated over the fronthaul network 120 to the APs 114 included in the simulcast zone of that base station 124. In one example, a multicast group is established for each different simulcast zone assigned to any base station 124 coupled to the vDAS 100. In such an example, the vMU 112 communicates the downlink transport data to the set of APs 114 serving the base station 124 by using one or more of the physical transport Ethernet interfaces 146 to transmit the downlink transport data as transport Ethernet packets addressed to the multicast group established for the simulcast zone associated with that base station 124. In this example, the vMU 112 is configured so that a part of the process of generating the downlink transport data includes formatting the transport Ethernet packets to use the address of the multicast group established for that simulcast zone. In another example, a separate virtual local area network (VLAN) is established for each different simulcast zone assigned to any base station 124 coupled to the vDAS 100, where only the APs 114 included in the associated simulcast zone and the associated vMUs 112 communicate data using that VLAN. In such an example, each vMU 112 is configured so that a part of the process of generating the downlink transport data includes formatting the transport Ethernet packets to be communicated with the VLAN established for that simulcast zone.

In another example, the vMU 112 broadcasts the downlink transport data to all of APs 114 of the vDAS 100 and each AP 114 is configured to determine if any downlink transport data it receives is intended for it. In this example, this can be done by including in the downlink transport data broadcast to the APs 114 a bitmap field that includes a respective bit position for each AP 114 included in the vDAS 100. Each bit position is set to one value (for example, a “1”) if the associated downlink transport data is intended for that AP 114 and is set to a different value (for example, a “0”) if the associated downlink transport data is not intended for that AP 114. In one such example, the bitmap is included in a header portion of the underlying message so that the AP 114 does not need to decode the entire message in order to determine if the associated message is intended for it or not. In one implementation, this can be done using an O-RAN section extension that is defined to include such a bitmap field in the common header fields. In this example, the vMU 112 is configured so that a part of the process of generating the downlink transport data includes formatting the downlink transport data to include a bitmap field, where the bit position for each AP 114 included in the base station's simulcast zone is set to the value (for example, a “1”) indicating that the data is intended for it and where the bit position for each AP 114 not included in the base station's simulcast zone is set to the other value (for example, a “0”) indicating that the data is not intended for it.

As a part of generating the downlink transport data, the vMU 112 performs any needed re-formatting or conversion of the received downlink base station data in order for it to comply with the format expected by the APs 114. For example, in the exemplary embodiment described here in connection with FIGS. 1A-1C and 2, the vDAS 100 is configured to use an O-RAN fronthaul interface for communications between the vMU 112 and the APs 114 and, as a result, the APs 114 are configured for use with, and to expect, fronthaul data formatted in accordance with the O-RAN fronthaul interface. In such an example, if the downlink base station data provided from the physical donor interface 126 to the vMU 112 is not already formatted in accordance with the O-RAN fronthaul interface, the vMU 112 re-formats and converts the downlink base station data so that the downlink transport data communicated to the APs 114 in the simulcast zone of the base station 124 is formatted in accordance with the O-RAN fronthaul interface used by the APs 114.

As noted above, in some implementations, both the content of the downlink transport data and the manner in which each vMU 112 generates the downlink transport data from the received downlink base station data depend on the functional split that is used by the associated base station 124 and, in other implementations, the content of the downlink transport data and the manner in which each vMU 112 generates the downlink transport data from the received downlink base station data is the same for all served base stations 124, regardless of the functional split used by the served base stations 124.

In those implementations where both the content of the downlink transport data and the manner in which each vMU 112 generates the downlink transport data from the received downlink base station data depend on the functional split that is used by the associated base station 124, if the base station 124 comprises a DU or BBU that is configured to use a functional split 7-2, the downlink transport data that is communicated between the vMU 112 and the APs 114 in the base station's simulcast zone comprises frequency-domain user-plane data and associated control-plane data for each antenna port of the base station 124. In such implementations, if a base station 124 comprises a DU or BBU that is configured to use functional split 4 or a where base station 124 comprises a “complete” base station that is coupled to a vMU 112, the downlink transport data that is communicated between the vMU 112 and the APs 114 in the base station's simulcast zone comprises time-domain user-plane data and associated control-plane data for each antenna port of the base station 124.

In one example of an implementation where the content of the downlink transport data and the manner in which each vMU 112 generates the downlink transport data from the received downlink base station data is the same for all served base stations 124 regardless of the functional split used by the served base stations 124, all downlink transport data is generated in accordance with a functional split 7-2 where the corresponding user-plane data comprises frequency-domain user-plane data. For example, where a base station 124 comprises a DU or BBU that is configured to use functional split 4 or where a base station 124 comprises a “complete” base station that is coupled to a vMU 112 using an analog RF interface, the downlink transport data that is communicated between each vMU 112 and each AP 114 in the base station's simulcast zone comprises frequency-domain user-plane data for each antenna port of the base station 124 and the vMU 112 converts the frequency-domain user-plane data to time-domain user-plane data. This can be done in order to reduce the amount of bandwidth used to transport such downlink transport data over the fronthaul network 120 (relative to communicating such user-plane data as time-domain user-plane data).

Each of the APs 114 associated with the base station 124 receives the downlink transport data, generates a respective set of downlink analog RF signals using the downlink transport data, and wirelessly transmits the respective set of analog RF signals from the respective set of coverage antennas 116 associated with that AP 114.

Where multicast addresses or VLANs are used for transmitting the downlink transport data to the APs 114 in a base station's simulcast zone, each AP 114 in the simulcast zone will receive the downlink transport data transmitted by the vMU 112 using that multicast address or VLAN.

Where downlink transport data is broadcast to all APs 114 of the vDAS 100 and the downlink transport data includes a bitmap field to indicate which APs 114 the data is intended for, all APs 114 for the vDAS 100 will receive the downlink transport data transmitted by the vMU 112 for a base station 124 but the bitmap field will be populated with data in which only the bit positions associated with the APs 114 in the base station's simulcast zone will be set to the bit value indicating that the data is intended for them and the bit positions associated with the other APs 114 will be set to the bit value indicating that the data is not intended for them. As a result, only those APs 114 in the base station's simulcast zone will fully process such downlink transport data, and the other APs 114 will discard the data after determining that it is not intended for them.

As noted above, how each AP 114 generates the set of downlink analog RF signals using the downlink transport data depends on the functional split used for communicating transport data between the vMUs 112 and the APs 114. For example, where the downlink transport data that is communicated between the vMU 112 and the APs 114 in the base station's simulcast zone comprises frequency-domain user-plane data and associated control-plane data for each antenna port of the base station 124, a RU entity implemented by each AP 114 is configured to perform the low physical layer baseband processing and RF functions for each antenna port of the base station 124 using the respective downlink transport data. This is done in order to generate a corresponding downlink RF signal for wireless transmission from a respective coverage antenna 116 associated with that AP 114. Where the downlink transport data that is communicated between the vMU 112 and the APs 114 in the base station's simulcast zone comprises time-domain user-plane data and associated control-plane data for each antenna port of the base station 124, a RU entity implemented by each AP 114 is configured to perform the RF functions for each antenna port of the base station 124 using the respective downlink transport data. This is done in order to generate a corresponding downlink RF signal for wireless transmission from a respective coverage antenna 116 associated with that AP 114.

In the uplink direction, each AP 114 included in the simulcast zone of a given base station 124 wirelessly receives a respective set of uplink RF analog signals (including the various physical channels and associated subcarriers) received by the set of coverage antennas 116 associated with that AP 114, generates uplink transport data from the received uplink RF analog signals and communicates the uplink transport data from the AP 114 to the vMU 112 coupled to the base station 124.

As noted above, how each AP 114 generates the uplink transport data from the set of uplink analog RF signals depends on the functional split used for communicating transport data between the vMUs 112 and the APs 114. Where the uplink transport data that is communicated between each AP 114 in the base station's simulcast zone and the serving vMU 112 comprises frequency-domain user-plane data for each antenna port of the base station 124, an RU entity implemented by each AP 114 is configured to perform the RF functions and low physical layer baseband processing for each antenna port of the base station 124 using the respective uplink analog RF signal. This is done in order to generate the corresponding uplink transport data for transmission over the fronthaul network 120 to the serving vMU 112. Where the uplink transport data that is communicated between each AP 114 in the base station's simulcast zone and the serving vMU 112 comprises time-domain user-plane data for each antenna port of the base station 124, an RU entity implemented by each AP 114 is configured to perform the RF functions for each antenna port of the base station 124 using the respective uplink analog RF signal. This is done in order to generate the corresponding uplink transport data for transmission over the fronthaul network 120 to the serving vMU 112.

The vMU 112 coupled to the base station 124 receives the uplink transport data transmitted from the APs 114 in the simulcast zone of the base station 124, generates uplink base station data from the uplink transport data received from the APs 114 in the simulcast zone of the base station 124, and provides the uplink base station data to the physical donor interface 126 coupled to the base station 124. The physical donor interface 126 coupled to the base station 124 generates one or more uplink base station signals from the uplink base station data and transmits the one or more uplink base station signals to the base station 124.

In this exemplary embodiment, generating the uplink base station data for a base station 124 involves, for each uplink antenna port of the base station 124, combining or summing corresponding user-plane data included in the uplink transport data received from all the APs 114 in the base station's simulcast zone. How the corresponding user-plane data is combined or summed depends on the functional split used for communicating transport data between the vMUs 112 and the APs 114.

The form that the uplink base station signals take and how the uplink base station signals are generated from the uplink base station data also depends on how the base station 124 is coupled to the vDAS 100.

For example, where an Ethernet-based interface is used (such as O-RAN, eCPRI, or RoE) to couple the base station 124 to the vDAS 100, the vMU 112 is configured to format the uplink base station data into messages formatted in accordance with the Ethernet-based interface. The messages are provided to the associated physical Ethernet donor interface 142. The physical Ethernet donor interface 142 generates Ethernet packets for communicating the provided messages to the base station 124 via one or more Ethernet ports of that physical Ethernet donor interface 142. That is, in this example, the “uplink base station signals” comprise the physical-layer signals used to communicate such Ethernet packets.

Where a CPRI-based fronthaul interface is used for communications between the physical donor interface 126 and the base station 124, the vMU 112 is configured to format the uplink base station data into messages formatted in accordance with the CPRI fronthaul interface. The messages are provided to the associated physical CPRI donor interface 138. The physical CPRI donor interface 138 generates CPRI frames for communicating the provided CPRI messages to the base station 124 via one or more CPRI ports of that physical CPRI donor interface 138. That is, in this example, the “uplink base station signals” comprise the physical-layer signals used to communicate such CPRI frames.

Where an analog RF interface is used for communications between the physical donor interface 126 and the base station 124, the vMU 112 is configured to provide the uplink base station data (comprising the combined (that is, digitally summed) time-domain baseband IQ data for each antenna port of the base station 124) to the associated physical RF donor interface 134. The physical RF donor interface 134 uses the provided uplink base station data to generate an uplink analog RF signal for each antenna port of the base station 124 (for example, by performing a digital upconversion and digital-to-analog (DAC) process). For each antenna port of the base station 124, the physical RF donor interface 134 outputs the respective uplink analog RF signal (including the various physical channels and associated subcarriers) to that antenna port using the appropriate RF port of the physical RF donor interface 134. That is, in this example, the “uplink base station signals” comprise the uplink analog RF signals output by the physical RF donor interface 134.

By implementing one or more nodes or functions of a traditional DAS (such as a CAN) using, or as, one or more VNFs 102 executing on one or more physical server computers 104, such nodes or functions can be implemented using COTS servers (for example, COTS servers of the type deployed in data centers or “clouds” maintained by enterprises, communication service providers, or cloud services providers) instead of custom, dedicated hardware. As a result, such nodes and functions can be deployed more cheaply and in a more scalable manner (for example, additional capacity can be added by instantiating additional VNFs 102 as needed). This is the case even if an additional physical server computer 104 is needed in order to instantiate a new vMU 112 because such physical server computers 104 are either already available in such deployments or can be easily added at a low cost (for example, because of the COTS nature of such hardware). Also, as noted above, this approach is especially well-suited for use in deployments in which base stations 124 from multiple wireless service operators share the same vDAS 100 (including, for example, neutral host deployments or deployments where one wireless service operator owns the vDAS 100 and provides other wireless service operators with access to its vDAS 100).

Other embodiments can be implemented in other ways. For example, FIGS. 3A-3D illustrates one such embodiment. FIGS. 3A-3D are block diagrams illustrating one exemplary embodiment of vDAS 300 in which at least some of the APs 314 are coupled to one or more vMU 112 serving them via one or more intermediate combining nodes (ICNs) 302. Each ICN 302 comprises at least one northbound Ethernet interface (NEI) 304 that couples the ICN 302 to Ethernet cabling used primarily for communicating with the one or more vMUs 112 and a plurality of southbound Ethernet interfaces (SEIs) 306 that couples the ICN 302 to Ethernet cabling used primarily for communicating with one or more of the plurality of APs 314.

Except as explicitly described here in connection with FIGS. 3A-3D, the vDAS 300 and the components thereof (including the vMU 112) are configured as described above. Also, except as explicitly described here in connection with FIGS. 3A-3D, each AP 314 is implemented in the same manner as the APs 114 described above.

The ICN 302 comprises one or more programmable devices 310 that execute, or are otherwise programmed or configured by, software, firmware, or configuration logic 312 in order to implement at least some of the functions described here as being performed by an ICN 302 (including, for example, any physical layer (Layer 1) baseband processing described here as being performed that ICN 302). The one or more programmable devices 310 can be implemented in various ways (for example, using programmable processors (such as microprocessors, co-processors, and processor cores integrated into other programmable devices) and/or programmable logic (such as FPGAs and system-on-chip packages)). Where multiple programmable devices are used, all of the programmable devices do not need to be implemented in the same way.

The ICN 302 can be implemented as a physical network function using dedicated, special-purpose hardware. Alternatively, the ICN 302 can be implemented as a virtual network function running on a physical server. For example, the ICN 302 can be implemented in the same manner as the vMU 112 described above in connection with FIGS. 1A-1C.

As noted above, the fronthaul network 320 used for transport between each vMU 112 and the APs 114 and ICNs 302 (and the APs 314 coupled thereto) can be implemented in various ways. Various examples of how the fronthaul network 320 can be implemented are illustrated in FIGS. 3A-3D. In the example shown in FIG. 3A, the fronthaul network 320 is implemented using a switched Ethernet network 322 that is used to communicatively couple each AP 114 and each ICN 302 (and the APs 314 coupled thereto) to each vMU 112 serving that AP 114 or 314 or ICN 302.

In the example shown in FIG. 3B, the fronthaul network 320 is implemented using only point-to-point Ethernet links 324, where each AP 114 and each ICN 302 (and the APs 314 coupled thereto) is coupled to each serving vMU 112 serving it via a respective one or more point-to-point Ethernet links 324. In the example shown in FIG. 3C, the fronthaul network 320 is implemented using a combination of a switched Ethernet network 322 and point-to-point Ethernet links 324. In the example shown in FIG. 3D, a first ICN 302 has a second ICN 302 subtended from it so that some APs 314 are communicatively coupled to the first ICN 302 via the second ICN 302. Again, as noted above, it is to be understood that FIGS. 1A-2C and 3A-2D illustrate only a few examples of how the fronthaul network (and the vDAS more generally) can be implemented and that other variations are possible.

In this exemplary embodiment, each vMU 112 that serves the ICN 302 treats the ICN 302 as one or more “virtual APs” to which it sends downlink transport data for one or more base stations 124, and from which it receives uplink transport data, for the one or more base stations 124. The ICN 302 forwards the downlink transport data to, and combines uplink transport data received from, one or more of the APs 314 coupled to the ICN 302.

In one implementation of such an embodiment, the ICN 302 forwards the downlink transport data it receives for all the served base stations 124 to all of the APs 314 coupled to the ICN 302 and combines uplink transport data it receives from all of the APs 314 coupled to the ICN 302 for all of the base stations 124 served by the ICN 302.

In another implementation, the ICN 302 is configured so that a separate subset of the APs 314 coupled to that ICN 302 can be specified for each base station 124 served by that ICN 302. In such an implementation, for each base station 124 served by an ICN 302, the ICN 302 forwards the downlink transport data it receives for that base station 124 to the respective subset of the APs 314 specified for that base station 124 and combines the uplink transport data it receives from the subset of the APs 314 specified for that base station 124. That is, in this implementation, each ICN 302 can be used to forward the downlink transport data for different served base stations 124 to different subsets of APs 314 and to combine uplink transport data the ICN 302 receives from different subsets of APs 314 for different served base stations 124. Various techniques can be used to do this. For example, the ICN 302 can be configured to inspect one or more fields (or other parts) of the received transport data to identify which base station 124 the transport data is associated with. In another implementation, the ICN 302 is configured to appear as different virtual APs for different served base stations 124 and is configured to inspect one or more fields (or other parts) of the received transport data to identify which virtual AP the transport data is intended for.

In the exemplary embodiments shown in FIGS. 3A-3D, each ICN 302 is configured to use a time synchronization protocol (for example, the Institute of Electrical and Electronics Engineers (IEEE) 1588 Precision Time Protocol (PTP) or the Synchronous Ethernet (SyncE) protocol) to synchronize itself to a timing master entity established for the vDAS 300 by communicating over the switched Ethernet network 122. Each AP 314 coupled to an ICN 302 is configured to synchronize itself to the time base used in the rest of the vDAS 300 based on the synchronous Ethernet communications provided from the ICN 302.

In one example of the operation of the vDAS 300 of FIGS. 3A-3D, in the downlink direction, each ICN 302 receives downlink transport data for the base stations 124 served by that ICN 302 and communicates, using the southbound Ethernet interfaces 306 of the ICN 302, the downlink transport data to one or more of the APs 314 coupled to ICN 302. As noted above, each vMU 112 that is coupled to a base station 124 served by an ICN 302 treats the ICN 302 as a virtual AP and addresses downlink transport data for that base station 124 to the ICN 302, which receives it using the northbound Ethernet interface 304.

As noted above, for each served base station 124, the ICN 302 forwards the downlink transport data it receives from the serving vMU 112 for that base station 124 to one or more of the APs 314 coupled to the ICN 302. For example, as noted above, the ICN 302 can be configured to simply forward the downlink transport data it receives for all served base stations 124 to all of the APs 314 coupled to the ICN 302 or the ICN 302 can be configured so that a separate subset of the APs 314 coupled to the ICN 302 can be specified for each served base station 124, where the ICN 302 is configured to forward the downlink transport data it receives for each served base station 124 to only the specific subset of APs 314 specified for that base station 124.

Each AP 314 coupled to the ICN 302 receives the downlink transport data transmitted to it, generates respective sets of downlink analog RF signals for all base stations 124 served by the ICN 302, and wirelessly transmits the downlink analog RF signals for all of the served base stations 124 from the set of coverage antennas 116 associated with the AP 314.

Each such AP 314 generates the respective set of downlink analog RF signals for all of the base stations 124 served by the ICN 302 as described above. That is, how each AP 314 generates the set of downlink analog RF signals using the downlink transport data depends on the functional split used for communicating transport data between the vMUs 112, ICNs 302, and the APs 114 and 314. For example, where the downlink transport data comprises frequency-domain user-plane data and associated control-plane data for each antenna port of the base station 124, a RU entity implemented by each AP 314 is configured to perform the low physical layer baseband processing and RF functions for each antenna port of the base station 124 using the respective downlink transport data. This is done in order to generate a corresponding downlink RF signal for wireless transmission from a respective coverage antenna 316 associated with that AP 314. Where the downlink transport data comprises time-domain user-plane data and associated control-plane data for each antenna port of the base station 124, a RU entity implemented by each AP 314 is configured to perform the RF functions for each antenna port of the base station 124 using the respective downlink transport data. This is done in order to generate a corresponding downlink RF signal for wireless transmission from a respective coverage antenna 316 associated with that AP 314.

In the uplink direction, each AP 314 coupled to the ICN 302 that is used to serve a base station 124 receives a respective set of uplink RF analog signals (including the various physical channels and associated subcarriers) for that served base station 124. The uplink RF analog signals are received by the AP 314 via the set of coverage antennas 116 associated with that AP 314. Each such AP 314 generates respective uplink transport data from the received uplink RF analog signals for the served base station 124 and communicates, using the respective Ethernet interface 210 of the AP 314, the uplink transport data to the ICN 302.

Each such AP 314 generates the respective uplink transport data from the received uplink analog RF signals for each served base station 124 served by the AP 314 as described above. That is, how each AP 314 generates the uplink transport data from the set of uplink analog RF signals depends on the functional split used for communicating transport data between the vMUs 112, ICNs 302, and the APs 114 and 314. Where the uplink transport data comprises frequency-domain user-plane data, an RU entity implemented by each AP 314 is configured to perform the RF functions and low physical layer baseband processing for each antenna port of the base station 124 using the respective uplink analog RF signal. This is done in order to generate the corresponding uplink transport data for transmission to the ICN 302. Where the uplink transport data comprises time-domain user-plane data, an RU entity implemented by each AP 314 is configured to perform the RF functions for each antenna port of the base station 124 using the respective uplink analog RF signal. This is done in order to generate the corresponding uplink transport data for transmission to the ICN 302.

The ICN 302 receives respective uplink transport data transmitted from the APs 314 coupled to the ICN 302 or any ICN 302 subtended from it. The respective uplink transport data transmitted from any subtended APs 314 and/or subtended ICNs 302 is received by the ICN 302 using the respective southbound Ethernet interfaces 306.

The ICN 302 extracts the respective uplink transport data for each served base station 124 and, for each served base station 124, combines or sums corresponding user-plane data included in the extracted uplink transport data received from the one or more subtended APs 314 and/or ICNs 302 coupled to that ICN 302 used to serve that base station 124. The manner in which each ICN 302 combines or sums the user-plane data depends on whether the user-plane data comprises time-domain data or frequency-domain data. Generally, the ICN 302 combines or sums the user-plane data in the same way that each vMU 112 does so.

The ICN 302 generates uplink transport data for each served base station 124 that includes the respective combined user-plane data for that base station 124 and communicates the combined uplink transport data for each served base station 124 to the vMU 112 associated with that base station 124 or an upstream ICN 302. In this exemplary embodiment described here in connection with FIGS. 3A-3D, an O-RAN fronthaul interface is used for communicating over the fronthaul network 120, and each ICN 302 is configured to generate and format the uplink transport data in accordance with that O-RAN fronthaul interface.

The ICN 302 shown in FIGS. 3A-3D can be used to increase the number of APs 314 that can be served by each vMU 112 while reducing the processing and bandwidth load relative to directly connecting the additional APs 314 to each such vMU 112.

FIG. 4 is a block diagram illustrating one exemplary embodiment of vDAS 400 in which one or more physical donor RF interfaces 434 are configured to by-pass the vMU 112.

Except as explicitly described here in connection with FIG. 4, the vDAS 400 and the components thereof are configured as described above.

In the exemplary embodiment shown in FIG. 4, the vDAS 400 includes at least one physical RF donor interface 434 that is configured to bypass the vMU 112 and instead, for the base stations 124 coupled to that physical RF donor interface 434, have that physical RF donor interface 434 perform those functions described above as being performed by the vMU 112. These functions include, for the downlink direction, receiving a set of downlink RF analog signals from each base station 124 coupled to the physical RF donor interface 434, generating downlink transport data from the set of downlink RF analog signals and communicating the downlink transport data to one or more of the APs 114 or ICNs 302 and, in the uplink direction, receiving respective uplink transport data from one or more APs 114 or ICNs 302, generating a set of uplink RF analog signals from the received uplink transport data (including performing any digital combining or summing of user-plane data), and providing the uplink RF analog signals to the appropriate base stations 124. In this exemplary embodiment, each physical RF donor interface 434 includes one or more physical Ethernet transport interfaces 448 for communicating the transport data to and from the APs 114 and ICNs 302 subtended from the physical RF donor interface 434. The vDAS 400 (and the physical RF donor interface 434) can be used with any of the configurations described above (including, for example, those shown in FIGS. 1A-1C and FIGS. 3A-3D).

The physical RF donor interface 434 can be used to reduce the overall latency associated with serving the base stations 124 coupled to that physical RF donor interface 434.

As noted above, various entities in the vDAS 100, 300, or 400 combine or sum uplink data. For example, in the exemplary embodiment described above in connection with FIGS. 1A-1C, as a part of generating the uplink base station data for each uplink antenna port of a base station 124, the corresponding vMU 112 combines or sums corresponding user-plane data included in the uplink transport data received from APs 114 in the base station's simulcast zone. In the exemplary embodiment described above in connection with FIGS. 3A-3D, each ICN 302 also performs uplink combining or summing in the same general manner that the vMU 112 does. Also, in the exemplary embodiment described above in connection with FIG. 4, each physical donor RF interface 434 that is configured to by-pass the vMU 112 also performs uplink combining or summing in the same general manner that the vMU 112 does.

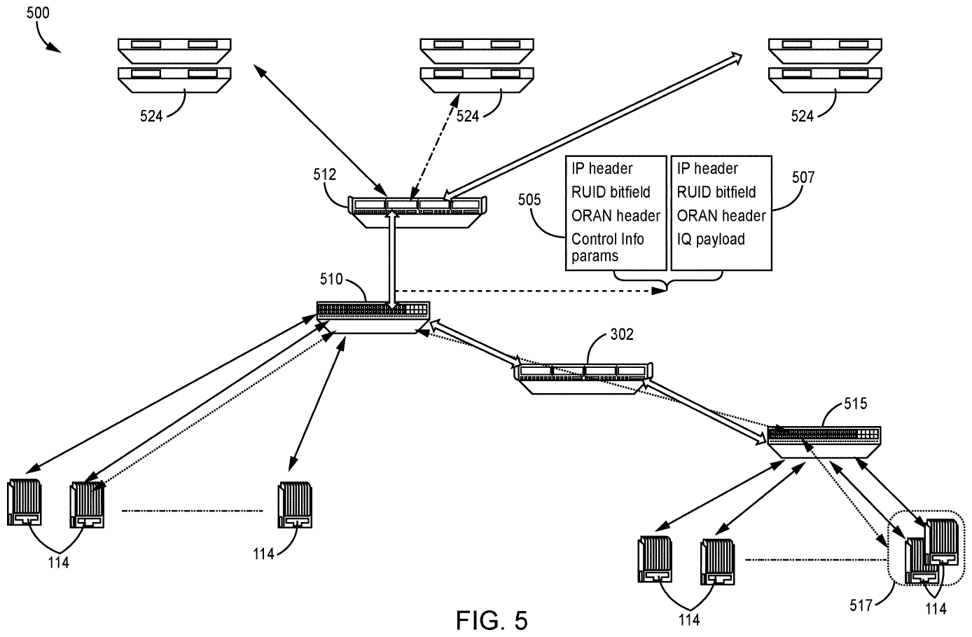

FIG. 5 is a block diagram of a system 500 that limits the transmission of certain packets to only intended RUs or APs 114. As shown, the system 500 includes one or more MUs 512 in communication with multiple base stations 524. An MU 512 may be a virtual MU like the MU 112 described above. Alternatively, the MU 512 may be a physical device in communication with the base stations 524. Additionally, an MU 512 may communicate with the base stations 524 similarly to the communications between the vMUs 112 and the base stations 124.

Further, the MU 512 may be coupled to an aggregate switch 510 within the system 500. In particular, the aggregate switch 510 facilitates the aggregate of data from the access points 114 to the MU 512 and the routing of data from the MU 512 to the appropriate access points 114. The aggregate switch 510 may be equipped with processing capabilities to handle various volumes of data, supporting different protocols, and other functions to support the aggregate and routing and data. In particular, the aggregate switch may route data to subsets of data based on data contained in messages to be sent to the particular access points 114.

In additional embodiments, the system 500 may include an ICN node 302, which functions similarly to the ICN node 302 described above. In some embodiments, the ICN node 302 may perform some of the functionality of the MU 512 for a subset of the access points 114. Also, the system 500 may include one or more access switches 515. An access switch 515, as described herein, may refer to a device that facilitates the aggregate of data from a subset of the access points 114 within the system for use by the ICN node 302 and the routing of data from the ICN node 302 to the appropriate access points 114 coupled to the access switch 114.

In certain embodiments, to control the routing of control-plane data 505 and user-plane data 507 to one or more of the connected access points 114, the MU 512 may insert routing information into the data to be transmitted that intermediate nodes can use to route the data to the appropriate access points 114. For example, the MU 512 may create a custom header that can be used by the aggregate switch 510, one or more ICN nodes 302, and access switches 515 to route the control-plane data 505 and the user-plane data 507 to the appropriate access points 114. When creating the custom header or other types of routing information like signature vectors, the MU may receive data from a base station 524 and identify destination information in the data (such as IP addresses) associated with the destination access points 114 for the data. For example, the MU 512 and/or the ICN node 302 may maintain a list of IP addresses per cell for the access points 114 that receive data from the MU 512 or ICN 302. From the list of IP addresses per cell, the MU 512 or ICN node 302 may place the IP address in the custom headers for the control-plane data 505 and the user-plane data 507. With the IP address information in the custom header, the MU 512, aggregate switch 510, ICN node 302, and access switches 515 may direct the packet along the paths associated with the destination IP addresses in the custom header of the transport packet for the control-plane data 505 and the user-plane data 507. Additionally, the MU 512 or ICN node 302 may insert a remote unit identification (RUID) bitfield within the header to identify which access points 114 are associated with transmitted data. As such, only the access points 114 along the specified paths may receive the packet, reducing the amount of data communicated through the fronthaul network between the MU and the access points 114.

In some embodiments, the custom header in the transport packets may be used by the MU 512 and the ICN node 302 to send the control-plane data 505 and the user-plane data 505 for PDSCH/UE specific channels and other signals transmitted over the fronthaul to only those access points 114 included in simulcast zones for user equipment (UE) associated with the intended destination. In particular, the MU 512 or ICN node 302 may identify access points 114 in simulcast zone 517. Thus, only the access points 114 in a simulcast zone 517 will use the transmitted control-plane data 505 and user-plane data 507 to generate analog RF signals for transmission from the access points 114 in the simulcast zone 517. Other control-plane and user-plane data for other downlink channels/signals (e.g., SSB/PDCCH/CSI-RS) may be communicated over the fronthaul network to all access points 114 serving a cell because the access points 114 use some general information in the control-plane data 505 and user-plane data 507 in connection with generating the analog RF signals wirelessly transmitted from the access points 114. By limiting the control-plane data 505 and user-plane data 507 transmitted to the access points 114, fronthaul bandwidth usage and the processing load of the access points 114 can be reduced.

In certain embodiments, where different combinations of access points are associated with different simulcast zones 517 and/or combining zones, a base station 524 or a DU may communicate fronthaul data with access points 114 in a simulcast/combining zone 517 for a UE through a fronthaul network. Generally, the respective simulcast zone 517 and combining zone for a UE includes those access points with the “best” or “strongest” signal reception or transmission characteristics for a particular UE.

In one exemplary embodiment, the simulcast zone 517 and combining zone for a UE can be determined by a serving DU or through the MU 512 using a “signature vector” (SV) associated with the UE. Each signature vector may include a respective element for each RU in communication with a base station 524. In one example of a signature vector, where a base station 524 communicates with 32 access points 114, each signature vector will include 32 elements, one for each of the 32 access points 114. Each element of the signature vector corresponds to one of the access points 114 associated with the base station 524. Additionally, each element of the signature vector may include one or more numerical values associated with the signal transmission or reception characteristics for the UE.

In certain embodiments, the elements of the signature vector for each UE can be determined by a base station 524 or master unit 512 based on information contained in uplink transmissions from the UE. The relative signal reception metrics are determined to represent which access points 114 will provide strong signal transmission and reception characteristics for transmitting downlink transmissions to the UE and receiving uplink transmissions from the UE. The relative signal reception metrics may also be determined to identify simulcast zones 517 for the UE. For example, the signature vector can be determined based on received power measurements made at each of the access points 115 for one or more uplink transmissions from the UE (for example, initially Physical Random Access Channel (PRACH) transmissions and thereafter Sounding Reference Signals (SRS) transmissions).

More specifically, each access point 114, upon receiving uplink transmissions, can measure or otherwise determine a signal reception metric indicative of the power level of the transmissions received by that access point 114 from the UE. One example of such a signal reception metric is a signal-to-interference plus noise ratio (SINR).

In some embodiments, each base station 524 or MU 512 may be configured to determine a signature vector for a UE upon connection to the cell (for example, based on a PRACH transmission and/or a previously determined signature vector for that UE) and update the signature vector for the UE over the course of the UE's connection to the cell based on SRS transmissions from the UE. For the purposes of determining and updating a UE's signature vector, each access point 114 can communicate the respective signal reception metrics periodically without an explicit request from the base station 524 and/or can communicate the signal reception metrics in response to an explicit request from the base station 524 (for example, using a polling mechanism).

One way that the respective signature vector determined for a given UE can be used to determine the respective simulcast zone 517 or combining zone for that UE is by using the signature vector to calculate a “total zone power” and a “total available power” for that UE. The total zone power for a given UE is the sum of the respective signal reception metrics determined for that UE corresponding to the access points 114 that are currently included in the zone under analysis. The “total available power” for the UE is the sum of the signal reception metrics determined for that UE that correspond to all of the access points 114. The simulcast zone 517 or combining zone for a UE can be determined by including enough access points 114 in the simulcast zone 517 for the UE so that the total zone power for the UE is within a threshold amount of the total available power for the UE. More specifically, a respective zone for a UE can be determined by starting with an empty zone for that UE, sorting the access points 114 based on the respective corresponding signal reception metrics determined for that UE in descending order from strongest power to weakest power, and adding, to the zone for that UE, successive access points 114 (according to the resulting sorted descending order) until the total zone power calculated for that UE is within a threshold amount of the respective total available power calculated for that UE or until the number of access points 114 included in the respective zone for that UE is equal to a predetermined maximum value (also referred to here as the “zone cap”). The size of a simulcast zone 517 or combining zone may be limited to the zone cap.

In some embodiments, the base station 524 may implement “frequency reuse.” As noted above, “downlink frequency reuse” refers to situations where separate downlink user data intended for different UEs is simultaneously wirelessly transmitted to the UEs using the same physical resource blocks (PRBs) for the same cell. Likewise, as noted above, “uplink frequency reuse” refers to situations where separate uplink user data is simultaneously wirelessly transmitted from different UEs using the same PRBs for the same cell. Generally, for those PRBs where downlink or uplink frequency reuse is used, the respective simulcast zone or the combining zone for the multiple UEs that are “in reuse together” have no access points 114 in common. Typically, frequency reuse can be used when the UEs in reuse together are sufficiently physically separated from each other so that the co-channel interference resulting from the different simultaneous wireless transmissions is sufficiently low (that is, where there is sufficient RF isolation).

Each base station may be configured to use all access points 114 to receive uplink transmissions from UEs on the Physical Random Access Channel (PRACH). This is because the PRACH is used by a UE, among other things, to access the cell initially and re-establish access after being idle. The base station 524 may have no simulcast zone or combining zone assigned to the UE, or the simulcast zone or combining zone assigned to the UE may be “stale” and not properly reflect the current location of the UE (for example, if the location of the UE changed significantly while the UE was an idle state).

Also, each base station 524 may update the signature vector (and, therefore, the simulcast zone 517 and combining zone) for each UE using SRS transmissions from that UE. Consequently, in this exemplary embodiment, each base station 524 may also use the available access points 114 to receive uplink SRS transmissions from UEs.

In some multi-radio unit deployments, the transmission of certain packets to a simulcast zone 517 for a UE may be sent over the fronthaul to all of the access points 114 serving a particular cell. The access points 114 that are not associated with the particular simulcast zone 517 may receive the simulcast-zone-specific control-plane and user-plane data even though the access points 114 do not use the control-plane and user-plane data in connection with generating the analog RF signals for wireless transmission. Thus, the access points 114 not associated with the particular simulcast zone 517 will discard control-plane and user-plane data that is intended for access points within the simulcast zone 517. For example, the access points 114 may identify such control-plane and user-plane data based on the RUID bitfield included in the headers of the control-plane and user-plane data.

In certain embodiments, in the downlink, control-plane, and user-plane data for PDSCH/UE specific channels and signals, the master unit 512 transmits the control-plane and user-plane data over the fronthaul to only those RUs in an associated UE's simulcast zone (517), either through an IP unicast transmission or an IP multicast transmission to a multicast group that only includes the RUs in the simulcast zone 517 for the associated UE (also referred to herein as “limited multicast” fronthaul transmission). Control-plane and user-plane data for the other downlink channels and signals that would be used by all of the access points 114 are transmitted over the fronthaul to all of the access points 114 used to serve the cell (also referred to herein as “full multicast” or “broadcast” fronthaul transmission). For example, control-plane and user-plane data for signals like the SSB, PDCCH, CSI-RS, and the like will be used by all of the access points 114 in connection with generating the analog RF signals wirelessly transmitted from those access points 114. Thus, the control-plane and user-plane data for these channels and signals are sent with a full multicast to all of the access points 114 serving the cell. In some embodiments, when a UE is discovered by the network, or an access point 114 is added to the system, the system may generate a unicast IP address for the joining access point 114 and a limited multicast IP address for the access points 114 in the simulcast zone for the UE. Accordingly, as described above, traffic through the fronthaul network can be reduced by limiting the data transmitted to all of the access points 114 in a DAS.

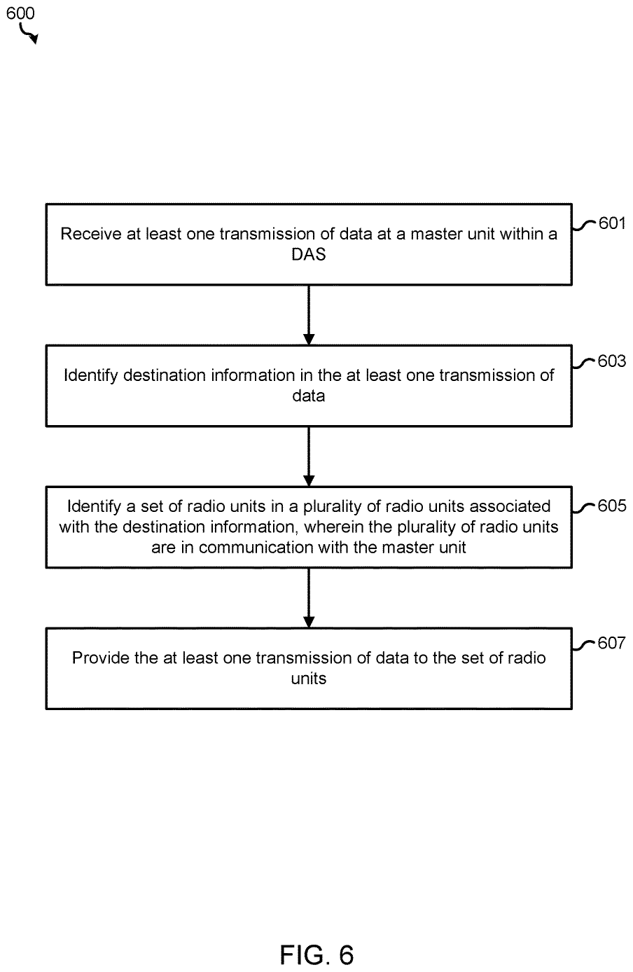

FIG. 6 is a flow chart diagram of a method 600 for improving fronthaul traffic to radio units within a DAS. For example, the method 600 proceeds at 601, where at least one transmission of data is received at a master unit within a DAS. Further, the method 600 proceeds at 603, where destination information in the at least one transmission of data is identified. Additionally, the method 600 proceeds at 605, where a set of radio units in a plurality of radio units associated with the destination information is identified, wherein the plurality of radio units are in communication with the master unit. Moreover, the method 600 proceeds at 607, where the at least one transmission of data is provided to the set of radio units.

### Example Embodiments

Example 1 includes a distributed antenna system (DAS) comprising: a master unit; and a plurality of radio units coupled to receive control-plane data and user-plane data from the master unit; wherein the master unit stores destination IP addresses for different combinations of radio units in the plurality of radio units, wherein the control-plane data and the user-plane data are transmitted to a combination of radio units in the different combinations of radio units associated with a specific destination IP address.
Example 2 includes the DAS of Example 1, wherein intermediate nodes route the control-plane data and the user-plane data to the combination of radio units associated with the specific destination IP address.
Example 3 includes the DAS of Example 2, wherein the intermediate nodes store destination IP address information associated with radio units in the plurality of radio units that are communicatively coupled to a respective intermediate node in the intermediate nodes.
Example 4 includes the DAS of any of Examples 2-3, wherein the intermediate nodes are at least one of: an aggregate switch; an access switch; and an intermediate combining node.
Example 5 includes the DAS of any of Examples 2-4, wherein the control-plane data and the user-plane data routed to the combination of radio units associated with the specific destination IP address are associated with at least one of: a physical downlink shared channel (PDSCH); and a user equipment specific channel.
Example 6 includes the DAS of any of Examples 2-5, wherein the intermediate nodes rout the control-plane data and the user-plane data to the plurality of radio units when the control-plane data and the user-plane data are associated with at least one of: a synchronization signal block (SSB); a physical downlink control channel (PDCCH); and a channel state information-reference signal (CSI-RS).
Example 7 includes the DAS of any of Examples 1-6, where the master unit generates the destination IP addresses when an RU joins a network associated with the master unit.
Example 8 includes the DAS of any of Examples 1-7, wherein a destination IP address in the destination IP addresses is at least one of: a limited multicast address; and a unicast address.
Example 9 includes a method comprising: receiving at least one transmission of data at a master unit within a distributed antenna system (DAS); identifying destination information in the at least one transmission of data; identifying a set of radio units in a plurality of radio units associated with the destination information, wherein the plurality of radio units are in communication with the master unit; and providing the at least one transmission of data to the set of radio units.
Example 10 includes the method of any of Examples 9-10wherein identifying the set of radio units comprises identifying at least one destination IP address for the set of radio units in a plurality of destination IP addresses stored on the master unit.
Example 11 includes the method of Example 10, further comprising generating the at least one destination IP addresses when an RU joins a network associated with the master unit.
Example 12 includes the method of any of Examples 10-11, wherein a destination IP address in the at least one destination IP addresses is at least one of: a limited multicast address; and a unicast address.
Example 13 includes the method of any of Examples 9-12, wherein providing the at least one transmission comprises routing control-plane data and user-plane data through one or more intermediate nodes within the DAS to radio units in the set of radio units based on the destination information.
Example 14 includes the method of Example 13, wherein the intermediate nodes store destination IP address information associated with the radio units in the set of radio units that are communicatively coupled to a respective intermediate node in the one or more intermediate nodes.
Example 15 includes the method of any of Examples 13-14, wherein the intermediate nodes are at least one of: an aggregate switch; an access switch; and an intermediate combining node.
Example 16 includes the method of any of Examples 9-15, wherein identifying the set of radio units comprises inserting routing information in the data to be transmitted to the set of radio units.
Example 17 includes a system comprising: a master unit configured to communicate with one or more base stations; one or more intermediate nodes configured to receive data from the master unit; and a plurality of radio units coupled to receive control-plane data and user-plane data from the master unit through the one or more intermediate nodes; wherein the master unit stores destination IP addresses for different combinations of radio units in the plurality of radio units, wherein the control-plane data and the user-plane data are transmitted to a combination of radio units in the different combinations of radio units associated with a specific destination IP address; wherein intermediate nodes route the control-plane data and the user-plane data to the combination of radio units associated with the specific destination IP address.
Example 18 includes the system of Example 17, wherein the intermediate nodes store destination IP address information associated with radio units in the plurality of radio units that are communicatively coupled to a respective intermediate node in the intermediate nodes.
Example 19 includes the system of any of Examples 17-18, where the master unit generates the destination IP addresses when an RU joins a network associated with the master unit.
Example 20 includes the system of any of Examples 17-19, wherein the master unit inserts routing information in the data to be transmitted to the combination of radio units.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed:

1. A distributed antenna system (DAS) comprising:
a master unit; and
a plurality of radio units coupled to receive control-plane data and user-plane data from the master unit;
wherein the master unit stores destination IP addresses for different combinations of radio units in the plurality of radio units, wherein the control-plane data and the user-plane data are transmitted to a combination of radio units in the different combinations of radio units associated with a specific destination IP address.

2. The DAS of claim 1, wherein intermediate nodes route the control-plane data and the user-plane data to the combination of radio units associated with the specific destination IP address.

3. The DAS of claim 2, wherein the intermediate nodes store destination IP address information associated with radio units in the plurality of radio units that are communicatively coupled to a respective intermediate node in the intermediate nodes.

4. The DAS of claim 2, wherein the intermediate nodes are at least one of:
an aggregate switch;
an access switch; and
an intermediate combining node.

5. The DAS of claim 2, wherein the control-plane data and the user-plane data routed to the combination of radio units associated with the specific destination IP address are associated with at least one of:
a physical downlink shared channel (PDSCH); and
a user equipment specific channel.

6. The DAS of claim 2, wherein the intermediate nodes rout the control-plane data and the user-plane data to the plurality of radio units when the control-plane data and the user-plane data are associated with at least one of:
a synchronization signal block (SSB);
a physical downlink control channel (PDCCH); and
a channel state information-reference signal (CSI-RS).

7. The DAS of claim 1, where the master unit generates the destination IP addresses when an RU joins a network associated with the master unit.

8. The DAS of claim 1, wherein a destination IP address in the destination IP addresses is at least one of:
a limited multicast address; and
a unicast address.

9. A method comprising:
receiving at least one transmission of data at a master unit within a distributed antenna system (DAS);
identifying destination information in the at least one transmission of data;
identifying a set of radio units in a plurality of radio units associated with the destination information, wherein the plurality of radio units are in communication with the master unit; and
providing the at least one transmission of data to the set of radio units.

10. The method of claim 9 wherein identifying the set of radio units comprises identifying at least one destination IP address for the set of radio units in a plurality of destination IP addresses stored on the master unit.

11. The method of claim 10, further comprising generating the at least one destination IP addresses when an RU joins a network associated with the master unit.

12. The method of claim 10, wherein a destination IP address in the at least one destination IP addresses is at least one of:
a limited multicast address; and
a unicast address.

13. The method of claim 9, wherein providing the at least one transmission comprises routing control-plane data and user-plane data through one or more intermediate nodes within the DAS to radio units in the set of radio units based on the destination information.

14. The method of claim 13, wherein the intermediate nodes store destination IP address information associated with the radio units in the set of radio units that are communicatively coupled to a respective intermediate node in the one or more intermediate nodes.

15. The method of claim 13, wherein the intermediate nodes are at least one of:
an aggregate switch;
an access switch; and
an intermediate combining node.

16. The method of claim 9, wherein identifying the set of radio units comprises inserting routing information in the data to be transmitted to the set of radio units.

17. A system comprising:
a master unit configured to communicate with one or more base stations;
one or more intermediate nodes configured to receive data from the master unit; and
a plurality of radio units coupled to receive control-plane data and user-plane data from the master unit through the one or more intermediate nodes;
wherein the master unit stores destination IP addresses for different combinations of radio units in the plurality of radio units, wherein the control-plane data and the user-plane data are transmitted to a combination of radio units in the different combinations of radio units associated with a specific destination IP address;
wherein intermediate nodes route the control-plane data and the user-plane data to the combination of radio units associated with the specific destination IP address.

18. The system of claim 17, wherein the intermediate nodes store destination IP address information associated with radio units in the plurality of radio units that are communicatively coupled to a respective intermediate node in the intermediate nodes.

19. The system of claim 17, where the master unit generates the destination IP addresses when an RU joins a network associated with the master unit.

20. The system of claim 17, wherein the master unit inserts routing information in the data to be transmitted to the combination of radio units.
